(19) United States
(12) Patent Application Publication
(10) Pub. No.: US 2025/0109872 A1
(43) Pub. Date: Apr. 3, 2025

(54) APPARATUS AND METHOD FOR HVAC EFFICIENCY MONITORING AND TRACKING

(71) Applicant: Dwellwell Analytics, Inc., Bethesda, MD (US)

(72) Inventors: Charles Gritton, Sterling, VA (US); Darryl Harlan Ngai, Washington, DC (US); Sami Kanderian, Germantown, MD (US); Daniel Simpkins, Bethesda, MD (US); Ali Taha, Staten Island, NY (US); Wilmer Jacob Zwietering, Utrecht (NL); Edwin Laurence Booth, Brooklyn, NY (US)

(21) Appl. No.: 18/834,212

(22) PCT Filed: Jan. 30, 2023
(86) PCT No.: PCT/US2023/011880

§ 371 Date: Jul. 29, 2024

Related U.S. Application Data
(63) Continuation of application No. 63/305,141, filed on Jan. 31, 2022.

(51) Int. Cl. F24F 11/38; F24F 11/52; F24F 11/64

(52) U.S. Cl. CPC F24F 11/38; F24F 11/52; F24F 11/64

(57) ABSTRACT

Example embodiments include an apparatus and a method for monitoring and reporting on HVAC performance. In an example method, an HVAC system is monitored to detect a plurality of sample intervals during which the HVAC system is active. The plurality of sample intervals may be, for example, a plurality of heating intervals and/or a plurality of cooling intervals. An ambient temperature or other environmental parameter is monitored to determine a change over each of the sample intervals. A sample value is determined for each of the sample intervals, each sample value representing a ratio between a duration of the interval and the temperature change over the course of the respective period. Statistics of the sample values are evaluated and may be used to identify changes in HVAC performance. Analogous methods preformed for periods of HVAC inactivity may be used to detect changes in heat retention performance.

### CROSS-REFERENCE TO RELATED APPLICATIONS

The present application claims benefit under 35 U.S.C. § 119 (e) from U.S. Provisional Patent Application Ser. No. 63/305,141, entitled “Apparatus and Method for HVAC Efficiency Monitoring and Tracking,” filed Jan. 31, 2022, which is hereby incorporated by reference in its entirety.

### BACKGROUND

The HVAC (heating, ventilation, air conditioning) system is usually the most expensive appliance in the home. It can be critical to human comfort and health as well as the safety of the home itself (e.g., mold, excessive dryness). However, these systems are often not monitored at all and so maintenance typically is failure-driven. In other words, the system has to fail first—often on the coldest day in the winter or hottest day of the summer—before the maintenance crew is called to investigate and fix.

As a result, not only are the repairs more expensive and the disruptions to the home more numerous and extreme but there are complicating secondary factors as well. The HVAC failures for the whole area tend to cluster on the coldest day in the winter or hottest day of the summer. That can make it difficult to schedule a repair person to fix the unit and can also lead to parts shortages which delay the time to repair.

### SUMMARY

A sensor node detects intervals during which an HVAC system is active (e.g. using sound and/or electrical transients). The node determines the time of the active interval (such as a heating period or a cooling period) and a change in temperature and/or another environmental parameter during the active interval. A histogram is generated in which a plurality of active intervals collected over a time period (e.g. over the course of a month or another time period) are binned based on the ratio of time to temperature change. An efficiency metric of the HVAC system is determined by fitting a predetermined curve type (e.g. “inverse gaussian”) to the histogram. Changes to the efficiency metric may trigger alerts of a potential HVAC fault.

Example embodiments include an apparatus and a method for monitoring and reporting on HVAC performance. In an example method, an HVAC system is monitored to detect a plurality of sample intervals during which the HVAC system is active. The plurality of sample intervals may be, for example, a plurality of heating intervals or a plurality of cooling intervals. An ambient temperature is monitored to determine a temperature change over each of the sample intervals. A sample value is determined for each of the sample intervals, each sample value representing a ratio or other metric between a duration of the interval and the change in temperature (or other environmental parameter) over the course of the respective period. Statistics of the sample values are evaluated and may be used to identify changes in HVAC performance. Use of statistical techniques may help to minimize the influence of factors that are not directly related to HVAC performance, such as different weather (outside temperature, wind, sunlight) and human activity (cooking, opening windows, etc.). Analogous methods preformed for periods of HVAC inactivity may be used to detect changes in heat retention and/or heat exclusion performance.

Example embodiments provide an ability to discriminate between heating and cooling cycles. Differentiation between heating and cooling cycles may be made in some embodiments without direct communication with the HVAC system. Some embodiments operate to compare between different HVAC systems within one house. Some embodiments operate to compare HVAC systems among different houses. Some embodiments operate to normalize the HVAC slopes for heating/cooling in different rooms for a comparable value. Some embodiments operate to normalize the temperature retention slopes for heating/cooling in different rooms for a comparable value. Some embodiments operate to compare temperature retention among different rooms. Some embodiments operate to compare temperature retention among different houses. Some embodiments operate to plot temperature retention as a function of outdoor temperature. Some embodiments use the relation between temperature retention and outdoor temperature to compare over time to see changes in insulation. Some embodiments use the relation between temperature retention and outdoor temperature to compare between rooms. Some embodiments use the relation between temperature retention and outdoor temperature to compare between units of apartments/houses. Some embodiments operate to determine and/or plot HVAC effectiveness as a function of outdoor temperature.

### BRIEF DESCRIPTION OF THE DRAWINGS

As illustrated in FIGS. 1A-1F, a device 100 includes a housing 108 having a rear surface 104. A set of power plug prongs 106 extends from the rear surface of the housing. Although the illustrated prongs are those compatible with standard North American outlets, other configurations may alternatively be used.

FIG. 2 is a graph providing a schematic example of a dirt loading curve for a filter.

FIG. 3 schematically illustrates a system in which heat Q flows between regions of different temperatures.

FIG. 4 is a graph schematically illustrating the performance of an example advanced multi-mode heat pump.

FIG. 5 provides example histograms of collections of sample values, which may be used as indicators of heating and/or cooling effectiveness.

FIG. 6 illustrates an example user interface providing a notification of a level of air filter cleanliness.

FIG. 7 is a histogram schematically representing the time divided by temperature change of HVAC cycles from a single sensor node, along with a curve fit to the histogram data.

FIGS. 8A-8B are histograms schematically representing data collected from two sensor nodes in the same home.

FIG. 9 illustrates an example user interface providing a report of collected data and results of data analysis.

FIG. 10 illustrates an example user interface providing statistical information on the detected operating cycles of an HVAC system.

FIGS. 11-13 illustrate examples of user interface elements providing different types of reports of heating effectiveness information.

FIGS. 14-16 illustrate examples of user interface elements providing different types of reports of cooling effectiveness information.

FIG. 17 illustrates an example of a user interface element in which temperature retention information is provided in some embodiments.

FIG. 18A illustrates an example of a user interface element in which temperature retention information is provided in some embodiments.

FIG. 18B illustrates a graphical display element used to display results in the example of FIG. 18A.

FIG. 19 illustrates a graphical display element used to display room-by-room temperature retention information in some embodiments.

FIG. 20 illustrates a graphical display element used to display temperature retention statistics in some embodiments.

FIGS. 21-22 illustrate graphical display elements used to display temperature swing information in some embodiments.

FIG. 23 schematically illustrates network topology used in some embodiments.

FIG. 24 is a schematic functional block diagram illustrating a sensor node used in some embodiments.

### DETAILED DESCRIPTION

As illustrated in FIGS. 1A-1F, a device 100 includes a housing 108 having a rear surface 104. A set of power plug prongs 106 extends from the rear surface of the housing. Although the illustrated prongs are those compatible with standard North American outlets, other configurations may alternatively be used.

The goal of example embodiment is to continually monitor the HVAC system's health and provide early warning of deterioration in performance and/or need for maintenance. This then augments the regular servicing visits with the ability to flag issues before a complete catastrophic breakdown.

### Overview of an Example Embodiment

In an example method, an HVAC system (e.g. of a residence) is monitored to detect a plurality of sample intervals during which the HVAC system is active. An ambient temperature is measured (e.g. by one or more sensor nodes disposed in the residence) to determine a change in temperature or other environmental parameter over each of the respective sample intervals. A sample value is determined for each of the sample intervals, each sample value representing a ratio between the duration of the interval and the temperature change over the course of the respective period. In some embodiments, the sample value may represent the duration divided by the temperature change. In other embodiments, the sample value may represent the temperature change divided by the duration. In further embodiments, the sample value may represent the slope of the change in temperature (or other environmental parameter) over time at or near the beginning of the interval.

In some embodiments, an environmental parameter other than temperature is used, following any of the techniques described herein. For example, a parameter representing humidity, comfort index, CO₂ level, or air quality may be tracked, and the effectiveness (or change in effectiveness) of an HVAC system may be monitored based on a collection of sample values, each sample value representing a rate of change in the relevant parameter during a respective active interval of the HVAC system. The value representing the rate of change may be, for example a slope of parameter change over unit time, or an inverse slope of time over unit parameter change.

In some embodiments, a change in HVAC performance may be detected based on a comparison between sample values collected in a first time period (e.g. a prior month or year) and sample values collected in a second time period (e.g. a current month or year). The comparison may be made based on statistical differences between the different collections of sample values. In some embodiments, data representing the changes to the HVAC performances is provided for display to a user.

For the purposes of the present disclosure, a system may be referred to as an HVAC system even if the system, for example, has only a cooling component or only a heating component, including systems such as PTAC, other portable air conditioners, and radiator systems.

Some embodiments include generating a histogram of the sample values and displaying the histogram to a user. Some embodiments include determining and displaying to a user at least one of the following: a mode, a median, an average, an upper percentile (e.g. upper quintile), or lower percentile (e.g. lower quintile) of the sample values.

In some embodiments, the method includes, for each of a plurality of bins, each bin being associated with a range of sample values, determining a number of the sample values that fall within the associated range to generate histogram data; and fitting a curve to the histogram data. The curve may be an inverse Gaussian (or Wald distribution).

Some embodiments include detecting a change in HVAC performance by detecting a change between (i) at least one first parameter of a first curve fitted to a first histogram of sample values collected in a first time period and (ii) at least one second parameter of a second curve fitted to a second histogram of sample values collected in a second time period.

In some embodiments, the sample intervals during which the HVAC system is active comprise sample intervals during which the HVAC system is heating. In some embodiments, the sample intervals during which the HVAC system is active comprise sample intervals during which the HVAC system is cooling. In some embodiments, both heating and cooling sample intervals are collected, and they may be processed separately.

In some embodiments, each sample interval is a single “on” cycle extending from a time the HVAC system becomes active to a time it becomes inactive. In some embodiments, each sample interval is an interval of a predetermined duration.

The collection of data as described here regarding active periods of the HVAC system may be used for providing various assessments of HVAC effectiveness as described in greater detail below. In addition, some embodiments collect data regarding inactive periods of the HVAC system, which may by used in determining the heat retention (e.g. insulation) and/or heat exclusion (e.g. shading) performance of the residence.

In an example method, an HVAC system is monitored to detect a plurality of sample intervals during which the HVAC system is inactive. An ambient temperature is monitored to determine a temperature change over each of the first and second plurality of sample intervals. A sample value is determined for each of the sample intervals, each sample value representing a ratio between a duration of the interval and the temperature change over the course of the respective period. In some embodiments, the sample value may represent the duration divided by the temperature change. In other embodiments, the sample value may represent the temperature change divided by the duration. In some embodiments, the sample value may represent a rate of temperature change at a particular time period during the inactive interval, such as at or the start of the interval (e.g., shortly after the HVAC system has become inactive).

A change in heat retention or exclusion performance may be detected based on a comparison between sample values collected in a first time period and sample values collected in a second time period. Such changes may be detected or characterized using statistical methods, including curve fitting, as summarized above (with respect to the “active” periods and as described in further detail below.

In some embodiments, a user is alerted to potential HVAC or heat retention issues in response to a determination that a value (such as mean, median, mode, or other value) derived from the sample values has changed by at least a threshold amount. The threshold may be, for example, a predetermined threshold, a user-defined threshold, or a contextually derived threshold.

Further described herein are embodiments in which sample values are processed for display using techniques that allow a user to readily identify changes or potential issues with HVAC or heat retention performance, for example showing comparisons of such processed data between different time periods, between different rooms (or different sensor nodes), or between dwellings that are expected to have comparable results.

In some embodiments, data presentation techniques are adjusted based on different levels of certainty regarding HVAC performance to provide users with useful information without conveying a misleading level of certainty.

In some embodiments, sample intervals in which the HVAC system is moving air (whether heating, cooling, or simply ventilating) are determined, and the total duration of such intervals is used to provide information as to an estimated remaining useful life of an HVAC filter. In some embodiments, the total duration of such intervals is used to provide information as to an estimated time to service or estimated time to failure of the HVAC system.

Some embodiments operate to determine temperature changes and intervals during which the HVAC system is heating, cooling, or ventilating without any direct communication with any component of the HVAC system itself. For example, one or more sensor nodes may be provided in a dwelling. In some embodiments, such nodes may be installed by plugging them into a household electrical socket. Each sensor node may include a temperature sensor, such as a thermocouple or other type of thermometer, for determining temperature changes. In some embodiments, each sensor node further includes a microphone, and the determination of times during which the HVAC system is heating, cooling, or ventilating is based at least in part on audio data collected using the microphone of one or more sensor nodes.

### HVAC Air Filter “Dirtiness” Metric Based on Operational Time

Some embodiments include the implementation of a remote monitoring system to measure HVAC air filter dirtiness over time based just on operational time. The input from the hub device or for this method may be the times when the HVAC system (or fan) is running.

In some embodiments, calculation is made of how dirty the air filter is by using the HVAC Operational Time. This may be implemented separately and distinctly from the methods of estimating HVAC Air Filter Dirtiness using, for example, trend analysis on HVAC Run Rate or direct classification of the acoustic signature of air ventilation sounds.

The following terms are used in the present disclosure:

| Term | Description |
|---|---|
| HVAC Operation | The length of time the HVAC air handler has been on since the air filter was last |
| Time | changed |
| Dust Holding | The amount of dust retained by the air filter at the point when the air pressure |
| Capacity | drop across the filter hits the Terminal Pressure Drop value. |
| Terminal | The pressure drop across the air filter reached when the air filter has reached the |
| Pressure Drop | end of its life. This also defines the Dust Holding Capacity of the filter. |
| Initial Pressure | The pressure drop across a clean air filter. |
| Drop | |

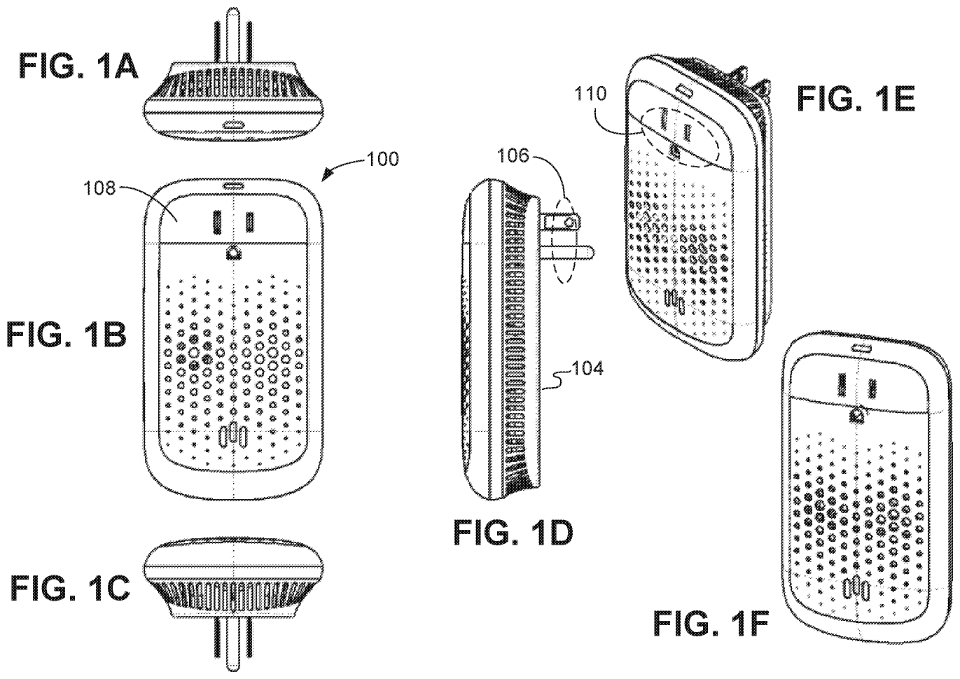

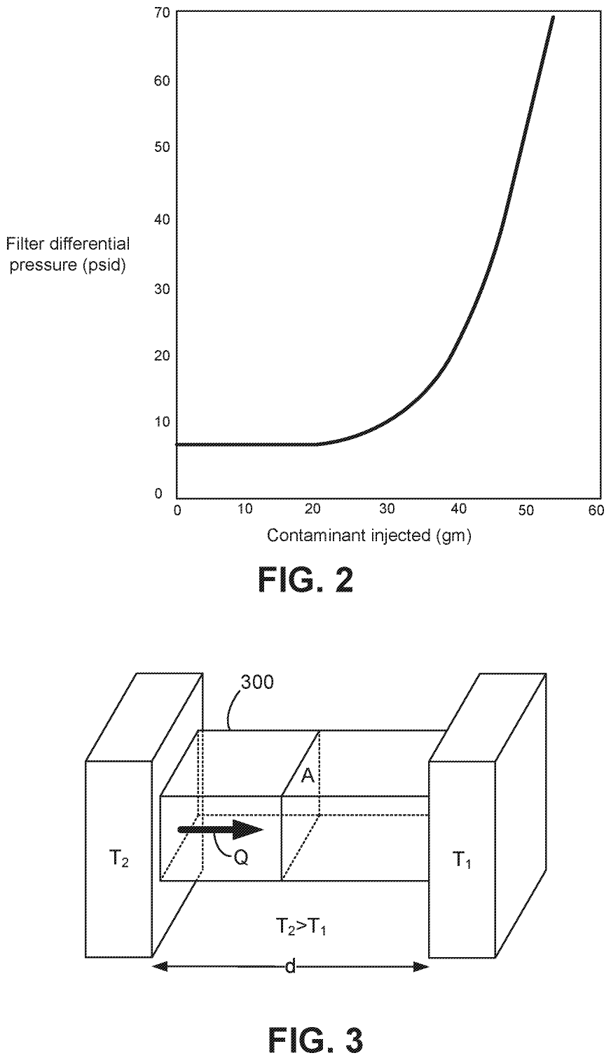

The air filter gradually picks up dust as air flows through it. Typically, HVAC air filters may be depth loading filters that capture particles throughout the depth of the media. Such filters may have a loading profile approximated by an exponential curve. (“Air Filtration: Predicting and Improving Indoor Air Quality and Energy Performance”, Ph.D. Thesis by James Montgomery, University of British Columbia, 2015, Section 6.1, p. 102) An example of a dirt loading curve for a hydraulic case is given in FIG. 2.

Note the curve is substantially exponential with the differential pressure staying nearly flat until roughly 30 grams of accumulated dust. The dust holding capacity is reached for this example at around 50 grams of accumulated dust. So there is very little or no change in differential pressure for the first 60% of its life. A recommendation may be made that the air filter should be changed when the differential pressure is double its initial value. That more or less happens at around 40 grams for this particular case. If we use that limit, then the air filter is pretty flat for the first 60% of its life (the same percentage noted by the source of this example dirt loading curve).

The presentation “Delivering Sustainability Promise to HVAC Air Filtration” by Dr. Christine Sun and Dan Woodman of Freudenberg Filtration Technologies, L.P., 2009 NAFA Annual Convention, Toronto, Canada, describes the exponential curve fit for various air filter types. The form is ΔP=a·e^{bx}, where x is the accumulated grams of dust. For a panel as used in some embodiments, parameters used may be a=36.21 and b=0.0027.

Example embodiments may use one or more of the following assumptions:
Assume a linear rate of dust accumulation on the filter as a function of HVAC Operational Time. This makes sense since the dust is distributed in the air and more dust will therefore be collected when there is air flow than when there is not. Assuming a constant average level of dust in the air and a constant average air flow throughout the life of the filter is reasonable. This is a slow metric operating over months and so short-term variations from the average in either dust concentration or air flow are not especially relevant.
Assume that the filter is a panel type that matches the exponential curve fit given above.
Assume that the recommended air filter change period of 3 months corresponds to the typical recommended operational time of 3 times per hour for 15-20 minutes at a time on average. Assume that the air filter manufacturers have designed their marketing around average run times across the country. While the general guidelines are that the operational time should be 2-3 times per hour for 15-20 minutes at a time, this over-estimates the total number. The following may be more accurate estimates:
   An average air conditioner runtime per day may be estimated as 8.9 hours. An average furnace operating time in the winter may be about 5.8 hours per day. Some embodiments use an estimate of 8.9 hours/day (534 minutes/day) all the time when estimating air filter life.
   This translates to 90 days*(534 minutes/day)=48,060 minutes of operational time before filter needs to be changed. A conservative estimate here may be 3 months, not 4 months for the base and also assuming the HVAC operational time that the filter manufacturers used was on the shorter end of normal.
It may be assumed that the differential air pressure at the end of 3 months is double the initial differential air pressure. Using the equation, that means a·e^{bx}/a=e^{bx}=2. Since we know b, we can compute x=ln(2)/b. Substituting the actual value of b in, we get x=ln(2)/0.0027=256.72. This is the assumed total amount of accumulated dust in the air filter at the end of 48,050 minutes of operation.

Some example methods embodiments may operate as follows:

$$Calculate current x as {x}_{current} = ( ( HVAC Operational Time in minutes ) / ( 48060 ) ) * 256.72 .$$

$$Calculate dirtiness percentage as dirtiness = ( {e}^{( \text{.0027} * xcurrent )} - 1 ) * 100 \% .$$

Note that in the above formula, dirtiness can exceed 100% if the homeowner continues operating the HVAC beyond the point where we've estimated the air filter should be changed. A user experience (UX) decision may determine whether to show that or to clamp it at 100%.

In some embodiments, X_{current} may be adjusted upward by a (multiplicative) factor if the homeowner has pets (more cats and dogs rather than fish) or a larger family. This reflects the fact that there will likely be more dust in the air to collect and the air filter then needs to be changed more frequently. The factor may be 1.5 if the homeowner has one cat or dog and 2 if they have more than one cat or dog. This information may be collected through a user interface.

In some embodiments, the estimate of dust buildup on the air filter may be adjusted based on humidity measurements.

### Example Thermal Calculation Overview

The change in energy in a thermal system is given by

ΔU=Q

where U is the total energy of our system and Q is the heat flow (in and out). For example embodiments, we have ignored the work done on the system and the only change in energy is due to heat flow.

The heat flow is related to the change in temperature by

Q=CΔT

where C is the heat capacitance of the system. Having more things inside the house raises the heat capacitance. This is why an empty room is warms up faster than a furniture filled room.

There may be several sources of heat flow in our system. One source is conduction from outside of a room. Conductive heat flow is represented by the following, where there is a temperature gradient ∇T

q=κ∇T

where κ is the thermal conductivity and q is the heat flux.

For a wall of thickness d, and assuming two uniform temperature bodies (the room and the outside), we have a system as illustrated in FIG. 3, in which heat flow is illustrated schematically by the arrow Q. The equation of the thermal conductance is

$$dQ / dt = ( κ A / d ) ( {T}_{2} - {T}_{1} )$$

where A is the surface area between the two bodies, d is the thickness of the wall (represented schematically by region 300), κ is the thermal conductivity of the wall material.

For the case of heat sources Q (positive for heating and negative for cooling).

Q=CΔT,

If we have two rooms, each with heating sources

$$C d {T}_{1} / dt = ( {κ}_{1} {A}_{1} / {d}_{1} ) ( {T}_{o} - {T}_{1} ) + ( {κ}_{1 - 2} {A}_{1 - 2} / {d}_{1 - 2} ) ( {T}_{2} - {T}_{1} ) + {dQ}_{H 1} / dt$$

$$d {T}_{1} / dt = {k}_{1} ( {T}_{o} - {T}_{1} ) + {k}_{1 - 2} ( {T}_{2} - {T}_{1} ) + {q}_{1}$$

$$Cd {T}_{2} / dt = {k}_{2} ( {T}_{o} - {T}_{2} ) + {k}_{1 - 2} ( {T}_{1} - {T}_{2} ) + {dQ}_{H 2} / dt$$

$$d {T}_{2} / dt = {k}_{2} ( {T}_{o} - {T}_{2} ) + {k}_{1 - 2} ( {T}_{1} - {T}_{2} ) + {q}_{2}$$

Here, we have 5 variables, k1, k2, k1−2, dQ_{H1}/dt, and dQ_{H2}/dt.

### HVAC Efficiency, Effective Outdoor Temperature

In some embodiments, various thermal model elements are combined to get a single effective outdoor temperature.

There are many factors that influence the temperature of the interior, such as the outside temperature, but also other aspects, such as the ground temperature influencing the basement. In some embodiments, to simplify the analysis, the various outdoor temperatures may be combined into a single effective temperature T_{eff}, and the heat conductance through various different components of a dwelling may be combined into a single effective heat conductance, k_{eff}.

### HVAC Effectiveness/Efficiency Method for User Interface

Some embodiments provide a detailed HVAC monitoring method that is based on a number of factors so that to provide useful insights into HVAC operation.

Example embodiments may operate to calculate one or more of the following parameters. Such parameters may be delivered to a user for display.

| Vsymbol | Parameter | Description |
|---|---|---|
| T-HVAC- | HVAC Daily Run | The total time during a day that the HVAC system ran |
| Run_{daily} | Time | (whether for heating or cooling). |
| T-Heat-Ave_{week} | Average Heating Run | The average (median) time the HVAC system ran over the past |
| | Time Over Week | week to raise the internal temperature by 1 degree C. |
| Heat-Effect | Heating Effectiveness | Ranging from 0% (broken) to 100% (as good as ever seen in this |
| | | install), this is an estimate of current heating efficiency including |
| | | normalization for outside temperature. |
| T-Cool-Ave_{week} | Average Cooling Run | The average (median) time the HVAC system ran over the past |
| | Time Over Week | week to reduce the internal temperature by 1 degree C. |
| Cool-Effect | Cooling Effectiveness | Ranging from 0% (broken) to 100% (as good as ever seen in this |
| | | install), this is an estimate of current cooling efficiency including |
| | | normalization for the difference between inside and outside |
| | | temperature. |
| T-Temp- | Average Temperature | The average (median) time it took for inside temperature to move |
| Retention_{week} | Retention Time Over | closer to outside temperature by 1 degree C. |
| | Week | |
| Temp- | Temperature | Ranging from 0% (no thermal resistance to outside at all) to 100% |
| Retention | Retention | (as good as ever seen in this install), this is an estimate of how |
| | Effectiveness | well the room/house retains temperature. The initial version does |
| | | not normalize for the effects of wind or sun. |

The performance of some HVAC equipment varies with the outdoor and sometimes indoor temperatures. The relevant details are below.

In general, the maximum energy efficiency ratio (EER) decreases as the temperature differential between the inside and outside air temperature increases. For an air conditioner, at lower outdoor temperatures, more of the cooling is performed with greater efficiency by the heat exchanger. At higher outdoor temperatures, more of the cooling is performed with less efficiency by the compressor.

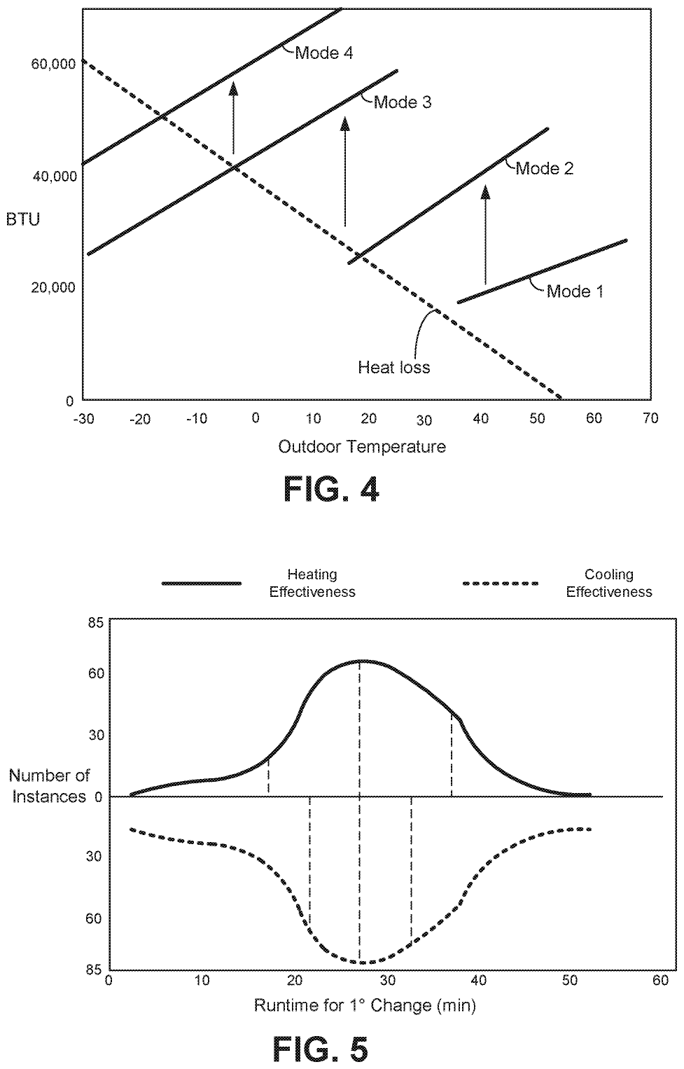

As for heating systems, some heating systems put out the same amount of heat regardless of the outdoor temperature, but this is not true for air source heat pumps. FIG. 4 schematically illustrates the performance of an example advanced multi-mode heat pump. The heat output within each mode (illustrated with solid lines) decreases with outdoor temperature. The appropriate mode is selected in an attempt to compensate for the heat lost from the home (illustrated with a dashed line), with the outdoor temperature triggering the change between modes. The vertical arrows represent transitions between modes as the outdoor temperature falls. While most heat pumps are significantly simpler than this one, the main point remains—the heat output decreases with outdoor temperature. Heat pumps may include a mode transition to electrical “emergency” heat when the temperature gets to a low temperature (generally around 30-40 degrees F. Example embodiments may operate on the assumption that measured HVAC efficiency for heating will depend on the outside air temperature.

Example embodiments may use one or more of the following parameters.

| Symbol | Parameter | Description |
|---|---|---|
| HRR_{c} | HVAC Run Rate for | The rate at which the HVAC system is cooling the |
| | Cooling | indoor temperature of the room the sensor node is in. |
| | | Units are ° C./sec |
| HRRₕ | HVAC Run Rate for | The rate at which the HVAC system is heating the indoor |
| | Heating | temperature of the room the sensor is in. Units are ° C/sec |
| k_{co} | Thermal Retention | When multiplied by the difference between inside and |
| | Factor | outside temperature, this gives the rate at which the |
| | | room/house is getting closer to the outside temperature. |
| | | Parameter units are sec⁻¹ |
| cb | Cooling Bin | Bin index for HVAC Run Rate history when cooling |
| HRR_{c}[cb].count | Cooling Bin Count | Number of readings for a given cooling bin index |
| HRR_{c-ref}[cb] | Reference HVAC Run | The reference value for the HVAC Run Rate for cooling |
| | Rate for Cooling | for this cooling bin index. It should represent the best |
| | | value seen for this system and cooling bin. |
| hb | Heating Bin | Bin index for HVAC Run Rate history when heating |
| HRRₕ[cb].count | Heating Bin Count | Number of readings for a given heating bin index |
| HRR_{h-ref}[hb] | Reference HVAC Run | The reference value for the HVAC Run Rate for heating |
| | Rate for Heating | for this heating bin index. It should represent the best |
| | | value seen for this system and heating bin. |
| HRR_{c}[cb].P50 | Median Cooling HVAC | Median HVAC Run Rate for a given cooling bin index |
| | Run Rate | |
| HRR_{c}[cb].P90 | P90 Cooling HVAC Run | 90^{th} Percentile HVAC Run Rate for a given cooling bin |
| | Rate | index (Avoid max so that outlier measurements are |
| | | suppressed) |
| HRR_{c}[cb].P10 | P10 Cooling Run Rate | 10^{th} Percentile HVAC Run Rate for a given cooling bin |
| | | index (Avoid max so that outlier measurements are |
| | | suppressed) |
| HE_{c}[cb] | HVAC Effectiveness | The HVAC Effectiveness for a given cooling bin index |
| | during cooling for cooling | from 0% to 100%. |
| | bin index cb | |
| HE_{c-week}[cb] | HE_{c}[cb] values restricted | The HVAC Effectiveness values for a given cooling bin |
| | to the current week | index for this week |
| HRRₕ[hb].P50 | Median Heating HVAC | Median HVAC Run Rate for a given heating bin index |
| | Run Rate | |
| HRRₕ[hb].P90 | P90 Heating HVAC Run | 90^{th} Percentile HVAC Run Rate for a given heating bin |
| | Rate | index (Avoid max so that outlier measurements are |
| | | suppressed) |
| HRRₕ[hb].P10 | P10 Heating Run Rate | 10^{th} Percentile HVAC Run Rate for a given heating bin |
| | | index (Avoid max so that outlier measurements are |
| | | suppressed) |
| HEₕ[hb] | HVAC Effectiveness | The HVAC Effectiveness for a given heating bin index |
| | during heating for | from 0% to 100%. |
| | heating bin index hb | |
| HE_{h-week}[hb] | HEₕ[hb] values restricted | The HVAC Effectiveness values for a given heating bin |
| | to the current week | index for this week |
| TRL | Temperature Retention | The list of k_{co} values with implicit ability to be indexed |
| | List of k_{co} values | by the time the underlying measurement was made |
| | | (i.e., the time the k_{co} value was estimated) |
| TRL_{week} | TRL values restricted to | The list of k_{co} values for the current week. |
| | the current week | |
| TRL.P10 | P10 Temperature | 10^{th} percentile value for the associated Temperature |
| | Retention value | Retention List TRL |
| TR_{ref} | Reference Temperature | The reference k_{co} value which should represent the best |
| | Retention value | value seen for this dNode. |
| TRE | Temperature Retention | Ranging from 0% (no thermal resistance to outside at all) |
| | Effectiveness | to 100% (as good as ever seen in this install), this is an |
| | | estimate of how well the room/house retains temperature. |
| | | Some embodiments do not normalize for the effects of |
| | | wind or sun. |
| Tᵢ | Internal temperature of | Internal temperature in degrees C. for room dNode is in |
| | room dNode is in | |
| Tₑ | Exterior (outside) | Outside temperature in degrees C. for house where |
| | temperature | system is installed |
| MIN_BIN_COUNT | Minimum number of | Minimum number of entries in bin required to do |
| | entries in bin required to | statistics; should be at least 3 |
| | do statistics | |
| PLOT_TIME_BASE | Minimum time value on | Minimum time value on x-axis for HVAC Effectiveness |
| | x-axis for HVAC | plots; should be no lower than 0 and typically is 1 |
| | Effectiveness plots | |
| PLOT_TIME_RES | Resolution of time values | Resolution of time values on x-axis for HVAC |
| | on x-axis for HVAC | Effectiveness plots; typically 0.1 minutes |
| | Effectiveness plots | |
| MAX_PLOT_TIME | Maximum time value on | Maximum time value on x-axis for HVAC Effectiveness |
| | x-axis for HVAC | plots; typically 20 minutes |
| | Effectiveness plots | |
| PLOT_MIN_COUNT | Minimum number of | Minimum number of entries in bin required to do |
| | entries in bin required to | statistics for Auxiliary Plots; should be at least 3 |
| | do statistics for Auxiliary | |
| | Plots | |

A simplified thermal model for the home that may be used in some embodiments is given as follows. This example model ignores other factors like sunlight, wind and room to room heat transfer within the house.

When the HVAC is off, dTᵢ/dt=−k_{co}*(Tᵢ−Tₑ).

When the HVAC is on, dTᵢ/dt=−k_{co}*(Tᵢ−Tₑ)+dT_{hvac}/dt

Note the equation may be the same whether the HVAC is heating or cooling.

Bin Readings. In example embodiments, each HVAC Run Rate reading is binned in order to assess true HVAC system efficiency trends.

Cooling. On receipt of a new HRR_{c} for a given sensor node, do the following. In some embodiments, the sensor node will supply Tᵢ and Tₑ for the calculations below. In some embodiments, these will be the values at the start of the cooling cycle.
Compute the appropriate cooling bin index:

$$c b = max ( ( {T}_{e} - {T}_{i} ) / 2 , 10 )$$

Add the HRR_{c} to the bin: HRR_{c}[cb].append(HRR_{c})

Heating. On receipt of a new HRRₕ for a given sensor node, do the following. In some embodiments, the sensor node will supply Tₑ for the calculations below. In some embodiments, these will be the values at the start of the heating cycle.
Compute the appropriate heating bin index:

$$h b = min ( ( max ( {T}_{e} , - 18 ) - ( - 18 ) ) / 2 , 20 )$$

Add the HRRₕ to the bin: HRRₕ[hb].append(HRRₕ)

Cooling or heating. On receipt of a new k_{co} for a given sensor node, add it to the list: TRL.append(k_{co}).

Compute un-normalized parameters. In some embodiments, the time-based parameters UX seeks (T-Cool-Ave_{week}, T-Heat-Ave_{week}, T-Temp-Retention_{week}) are all referenced to a 1 degree C. change. The HRR and T-Temp-Retention values on which this is based have units which may be inverted to yield the desired values. For example, if the HRR run rate is 0.25 degrees C. per second, the T-Cool reading UX seeks is (1 degrees C.)/(0.25 degrees C. per second) or 4 seconds.

$$T - Cool - {Ave}_{week} = 1. / median ( {HRR}_{c - week} [ cb ] for all cb where ( {HRR}_{c - week} [ cb ] . count > MIN\_BIN \_COUNT ) )$$

$$T - Heat - {Ave}_{week} = 1. / median ( {HRR}_{h - week} [ hb ] for all hb where ( {HRR}_{h - week} [ hb ] . count > MIN\_BIN \_COUNT ) )$$

$$T - Temp {Retention}_{week} = 1. / median ( abs ( ( {k}_{co} for this past week ) * ( {T}_{i} - {T}_{e} ) ) )$$

Determine Reference Values for Computing Normalized Parameters. Note that min rather than max is used in computing the reference HRR's. That's because we desire to capture the peak operation and that will happen when the time to change the temperature by 1 degree C. is the shortest

$${HRR}_{c - ref} [ cb ] = min ( {HRR}_{c - week} [ cb ] . P 10 , {HRR}_{c - ref} [ cb ] ) if {HRR}_{c - week} [ cb ] . count > MIN\_BIN \_COUNT )$$

$${HRR}_{h - ref} [ hb ] = min ( {HRR}_{h - week} [ hb ] . P 10 , {HRR}_{h - ref} [ hb ] ) if {HRR}_{h - week} [ hb ] . count > MIN\_BIN \_COUNT )$$

When dealing with Temperature Retention, some embodiments evaluate the minimum value because the k_{co} term is multiplied by the difference between interior and exterior temperatures to yield the rate of change in degrees Celsius per unit time. Therefore the smaller k_{co} becomes, the better the Temperature Retention.

TR_{ref}=min(TRL_{week}.P10, TR_{ref})

Other embodiments may alternatively use the maximum, mode, or some other measure in place of the minimum.

Compute normalized parameters. Normalized parameters may be determined as follows.

$${HE}_{c} [ cb ] = ( median ( {HRR}_{c} [ cb ] / {HRR}_{c - ref} [ cb ] ) * 100 \% ) if {HRR}_{c - ref} [ cb ] valid$$

$$Cool - Effect = median ( {HE}_{c - week} [ cb ] for all cb where ( {HE}_{c - week} [ cb ] . count > MIN\_BIN \_COUNT ) )$$

$${HE}_{h} [ hb ] = ( median ( {HRR}_{h} [ hb ] / {HRR}_{h - ref} [ hb ] ) * 100 \% ) if {HRR}_{h - ref} [ hb ] valid$$

$$Heat - Effect = median ( {HE}_{h - week} [ hb ] for all hb where ( {HE}_{h - week} [ hb ] . count > MIN\_BIN \_COUNT ) )$$

$$Temperature Retention Effectiveness = TRE = ( median ( {TRL}_{week} / {TR}_{ref} ) * 100 \% ) if {TR}_{ref} valid$$

Derive HVAC Effectiveness Plots. As an alternate visualization to the summary metrics computed above, some embodiments operate to graphically illustrate HVAC Effectiveness by plotting HRR_{c} and HRRₕ for a recent period of time.

As noted above, in general HVAC performance varies with weather and not just its maintenance condition. That's why the calculations of HE_{c} and HEₕ are normalized to bins that factor in weather conditions. This plot does not directly leverage bins and so will change with weather conditions. However, since we seek to minimize that effect, it may be desirable to pick an appropriate window of time. This is a design parameter that can be changed, but in some embodiments, it is to set it to 1 month, which is long enough to capture a broad collection of bins but short enough that seasonal variations can be seen.

The nominally 1 month period mentioned below may be a sliding window of time. This means that what we are plotting is the current day's results plus the prior 30 days. This is then a sliding month, not a calendar month.

There will be times when the HVAC system only heats (e.g., winter) or only cools (e.g., summer). In that event, only one of the two possible curves will be shown because there is no data for the other.

HVAC systems average just shy of 9 hours a day but generally 10-15 minutes at a time. This will vary for a particular house but suggests that the default x-axis range should be roughly 1 to 30 minutes to a resolution of 0.1 minute.

To calculate plot data, the following may be performed in some embodiments:

Define macro IN_RANGE(value, low, delta)=((value>=low) && (value<(low+delta)))

For I=0 to ((MAX_PLOT_TIME−PLOT_TIME_BASE)/PLOT_TIME_RES):

$${HRR}_{c - plot} [ i ] = sum ( [ 1 for v in {HRR}_{c} [ : ] [ : ] if v in IN\_RANGE ( i * PLOT\_TIME \_RES + PLOT\_TIME \_BASE , PLOT\_TIME \_RES ) ) ] )$$

$${HRR}_{h - plot} [ i ] = sum ( [ 1 for v in {HRR}_{h} [ : ] [ : ] if v in IN\_RANGE ( i * PLOT\_TIME \_RES + PLOT\_TIME \_BASE , PLOT\_TIME \_RES ) ) ] )$$

In the above calculation if there are HRR values greater than the last plot time, they will not be counted. If MAX_PLOT_TIME is set to allow this to happen, in some embodiments, all the values greater than the highest bin may be collected together into that bin.

Calculating auxiliary plot data. Calculation of auxiliary plot data may include defining a function such as PERCENT_FIND(x, p), where:
x is the list of counts from index 0 at the low end and some finite number M at the high end so the array contains M+1 entries. Here x will be either HRR_{c-plot} and HRRₕ₋ₚₗₒₜ.
p is the desired percentile which represents the cumulative percentage of counts from 0 up to the returned index is >=this percentage. To ease calculation, it is presumed in some embodiments that the returned index is fractional to allow for better handling of edge cases.

The method in Python-like pseudo-code may be implemented as follows.

```
desired_sum = p * sum(x) #if p = 50 and the sum of all the counts in the
array x is 120, desired_sum is 60
sine (50/100)*120 = 60
cum_sum = 0
for j = 0 to len(x):
  cum_sum += x[j]
  if cum_sum > = desired_sum
    break
if cum_sum < desired_sum:
  log.error( )
else
  “‘ x[j] moved cum_sum from below desired_sum to above it and so
  want to take back the fraction that
  is above desired_sum
  ret_index = j − (cum_sum − desired_sum)/x[j]
```

In some embodiments, statistics obtained from the main plot data are plotted. This may be performed as follows.

HRR_{c-plot}. P90=PERCENT_FIND(HRR_{c-plot}, 90)

HRR_{c-plot}. P50=PERCENT_FIND(HRR_{c-plot}, 50)

HRR_{c-plot}. P10=PERCENT_FIND(HRR_{c-plot}, 10)

Similarly the heating values may be computed as follows:

HRRₕ₋ₚₗₒₜ. P90=PERCENT_FIND(HRRₕ₋ₚₗₒₜ, 90)

HRRₕ₋ₚₗₒₜ. P50=PERCENT_FIND(HRRₕ₋ₚₗₒₜ, 50)

HRRₕ₋ₚₗₒₜ. P10=PERCENT_FIND(HRRₕ₋ₚₗₒₜ, 10)

For this option, the method may involve plotting these three values by day or week for the period chosen. Each single data point represents a calculation for the past window of time (here recommended to be 1 month long). So the plot shows how the statistics of the HVAC Effectiveness plots changes over time.

In some embodiments, statistics across bins are plotted.

The HRR's are normalized by bins and so shifts within a bin should correlate to changes in the system's operational efficiency. In some embodiments, the 90%, 50% (median) and 10% points may be plotted per bin against the temperature values the bins correspond to (e.g., the outside temperature is the x-axis for the heating case) for cooling and heating respectively. The formulas to calculate the relevant stats on HRR in some embodiments are given below.

HRR-P90_{c-plot}[;]=[HRR_{c}[cb].P90 for all cb where HRR_{c}[cb].count>=PLOT_MIN_COUNT]

HRR-P50_{c-plot}[;]=[HRR_{c}[cb].P50 for all cb where HRR_{c}[cb].count>=PLOT_MIN_COUNT]

HRR-P10_{c-plot}[;]=[HRR_{c}[cb].P10 for all cb where HRR_{c}[cb].count>=PLOT_MIN_COUNT]

HRR-P90ₕ₋ₚₗₒₜ[;]=[HRRₕ[hb].P90 for all hb where HRRₕ[hb].count>=PLOT_MIN_COUNT]

HRR-P50ₕ₋ₚₗₒₜ[;]=[HRRₕ[hb].P50 for all hb where HRRₕ[hb].count>=PLOT_MIN_COUNT]

HRR-P10ₕ₋ₚₗₒₜ[;]=[HRRₕ[hb].P10 for all hb where HRRₕ[hb].count>=PLOT_MIN_COUNT]

### Distribution-Centric HVAC Efficiency Model

Some embodiments provide for a simplified analytical model. Powerful insights can be had by, in this case, letting collections over longer periods of time average out the factors which may otherwise be considered.

Modeling HVAC and home thermal behavior in general is complicated. Example embodiments operate to determine relevant parameters via remote sensing using a collection of sensor nodes in the home (e.g. using audio data collected by sensor nodes for determining HVAC activity). Such embodiments provide useful and actionable insights for those who own and/or manage a home.

While the example is described here of an HVAC system cooling a house, the description also applies to cases where the HVAC system is heating the house, only the direction of temperature change is different.

In example embodiments, analysis is performed based on two types of observations, collected over a relatively long period of time:
When the HVAC system is running, how long it takes to reduce the room temperature by 1° C. The symbol OnTime may represent this value.
When the HVAC system is not running, how long it takes for the room temperature to rise by 1° C. The symbol OffTime may represent this value.

In some embodiments, for each HVAC “On” cycle for each sensor node of interest, a new OnTime is calculated. Similarly, for each HVAC “Off” cycle for each sensor node of interest, a new OffTime is calculated. Then, if one plots the distribution (e.g. a histogram) of OnTime values seen over a long period of time, the result may be a graph as shown in FIG. 5. The distribution of OffTime may be similar.

The distributions of OnTime and OffTime are valuable in and of themselves, as described below. In addition, example embodiments operate to compare the distributions of two time-periods with one another. For example, some embodiments compare the current year's OnTime distribution with the prior year's OnTime distribution, and if the HVAC system is degrading, the distribution may indicate a shift towards longer times. Some embodiments operate to detect such a shift and to alert a user to potential changes to the effectiveness of the HVAC system. In particular, some of the peak (or mode), median, mean, lower quintile and upper quintile values may be greater than before. If those values are the same, that indicates the HVAC system is running at substantially the same efficiency level as before.

The situation with OffTime is similar. Example embodiments operate to compare the current year's OffTime distribution with the prior year's OffTime distribution and if the home's thermal retention is worse, the distribution may indicate a shift towards shorter times. Some embodiments operate to detect such a shift and to alert a user to potential changes to the effectiveness of the home's heat retention (e.g. insulation) or exclusion (e.g. shading). In particular, some of the peak, median, lower quintile and upper quintile values may be less than before. If those values are the same, that indicates the home's thermal retention is roughly the same as before.

Some embodiments operate to compare the OnTime distribution for one sensor node with another in the same house. A determination may be made that the one with longer times is not as well controlled. This could indicate that, due to duct design or vent position, the air flow is not as strong in the poorer performing room. It could mean that the thermal retention in that room is lower That in turn could be due to poorer insulation, an open window or the like. Or it could mean another heat source is dragging down performance such as solar radiation. One example is if the poorer performing room has many windows and gets lots of sunlight.

Some embodiments operate to compare the OffTime distribution for one sensor node with another in the same house. A determination may be made that the node with shorter times has poorer insulation, which may be the result, for example of poor wall insulation or an open window.

In some embodiments, a comparison is performed of distributions from similar homes in the same geographic area. A determination may be made of how well a particular home/room is performing relative to neighboring homes. In some embodiments, a comparison is performed of distributions from different HVAC units in a single house or different HVAC units in different units of a multi-dwelling building such as an apartment building. Other comparisons may alternatively be made.

A comparison of two OnTime distributions is particularly useful when the distributions of correlated factors are roughly equivalent. For example, OnTime is heavily influenced by weather conditions. Comparing two distributions with different outdoor temperature patterns may lead to erroneous conclusions. Thus, if it is desired to compare the OnTime distributions for one sensor node in a house against one for another sensor node in the same house, it is desirable to use a period long enough to get a decent statistical average (e.g. a week or month). If it is desired to compare the current OnTime distribution against a prior time, it is desirable for both time periods to have roughly the same distribution of weather conditions (and indoor thermostat settings). Since weather patterns can change a bit from year to year, in some embodiments, the periods of time are relatively long—say the last 12 months against the 12 months prior to that (the current year against last year).

In some embodiments, to compare two OffTime distributions, it is desirable to have information indicating that the distributions of correlated factors are roughly equivalent. In addition to weather, the main factors involved concern the layout and house orientation, the building materials, the number of windows and the like. The main result, therefore, is that the same general guidelines apply as detailed above for comparing OnTime distributions.

In some embodiments, a simplified thermal model is used to estimate the thermal retention and HVAC efficiency parameters. Analyzing those distributions separately with a binned approach as described herein allows for comparison of distributions across shorter periods of time.

### HVAC Efficiency (Random Walk and Inverse Gaussian)

Some embodiments fit a histogram of HVAC Efficiency Ratios to a curve, such as an Inverse Gaussian curve. By fitting an Inverse Gaussian to the collected data, the resulting data may be presented in a more easily interpretable form for monitoring the performance of the system. For example, there is a closed form equation for both the mode and the mean of that curve. By using the fit distribution instead of the raw histogram bins, example embodiments are more robust to statistical variations and measurement noise. In example embodiments, the curve is fit to the data with a low number of variables, e.g. two variables for shape and one for height normalization, where the variables provide information regarding the HVAC efficiency.

When an HVAC system deteriorates or ages in performance, the peak of the fit distribution will generally shift to the right. Detecting this shift gives us a view into HVAC performance. Even comparing the distribution values (mean, mode, standard deviation) across units/homes can provide information the relative performance of the system, and changes in one or more such parameters (e.g. changes that exceed a threshold, which may be a predetermined threshold) may be used to indicate a loss of HVAC performance.

Some embodiments operate to scale the histogram values from one dNode in the home to augment the histogram values from another dNode in the home. For example, different sensor nodes may be placed in different-sized rooms, sensor nodes may have different distances from a vent, and there may be furniture or other obstacles between a vent (or radiator, etc.) and a sensor node. Such differences in room configurations may lead to differences in heating and cooling times. Despite these differences, data from different sensor nodes can be compared by re-scaling the data.

Example embodiments use artificial intelligence (AI) classifiers to determine when the HVAC is on and off. For example, audio data collected by sensor nodes may be converted into a spectrogram that in turn is provided to a convolutional neural network (CNN) trained to discriminate between HVAC active and inactive states. In some embodiments, additional information collected by additional sensors is used. Such additional sensors may be in the same sensor node. Such additional sensor information may include electrical transient signals detected at a power outlet, changes to temperature, humidity, or detected levels of different gases (e.g. CO, CO₂, or volatile organic compounds) that can be used as an alternative to or in addition to audio signals to provide greater levels of certainty as to the activity, inactivity, and type of activity (e.g. heating, cooling, or ventilating) of the HVAC system. Information from exterior sources may also be employed. For example, external temperature values may be determined (detected through an outdoor sensor or retrieved via online weather resources), with high outdoor temperatures increasing a prior probability of HVAC cooling activity and lower outdoor temperatures increasing a prior probability of HVAC heating activity. This information is used to help determine the efficiency of heating/cooling of the HVAC. In some embodiments, data is further collected from a thermostat. Such data may indicate whether the thermostat has requested activation of the HVAC system. Thermostat data may be used to augment a determination made using other sensor data (e.g. audio data) to determine whether the HVAC system is active. Furthermore, a potential failure state may be detected if the thermostat has requested activation of the HVAC system but other sensor data (e.g. audio data and/or temperature data) indicates that the HVAC system has not been activated.

In some embodiments, for each HVAC “on” cycle, the total duration and temperature change are measured. The value of time divided by temperature change is determined, where a higher value means that it is less efficient as it takes longer for the HVAC to change the temperature of the room by a set amount.

FIG. 7 illustrates a histogram showing the time divided by temperature change of HVAC cycles from a single sensor node. Investigations have shown that the overlay with an inverse Gaussian distribution fits the data well. The observation that such an overlay fits well for this histogram opens the door to some embodiments as disclosed herein.

The observation that the inverse Gaussian distribution (or “Wald distribution”) fits the histogram well indicates that the heating/cooling of the room is well modelled as heating/cooling from the HVAC plus environmental heating/cooling, where the environmental term is random and has a normal distribution. In general, the mean is proportional to the size of the room and the heat flow rate from the HVAC and is substantially independent of the environmental heating/cooling. The environmental heating/cooling only affects the variance of the distribution (width of the distribution).

In some embodiments, to determine HVAC efficiency, one sensor node is chosen for each HVAC/PTAC zone. The choice may be made through the input of a user, an installation professional, or it may be made automatically.

In some embodiments, the histogram could be fitted to the inverse gaussian distribution given by:

$$f ( x ) = β \sqrt{\frac{λ}{2 π {x}^{3}}} {e}^{- \frac{{λ ( x - μ )}^{2}}{2 {μ}^{2} x}}$$

where
mu=the mean of the distribution
lambda=(mean of the distribution)³/(variance of the distribution)
beta=Fitted to match the height. This would vary depending on the data binning for the histogram.

In some embodiments, data is taken from multiple sensor nodes to describe the HVAC efficiency of the full house. As noted above, the mean of the distribution scales proportionally to the heat capacitance of the room. So a room of larger size would have a larger distribution mean than a smaller room. For example, a large living room would have a higher mean HVAC efficiency distribution than a bathroom.

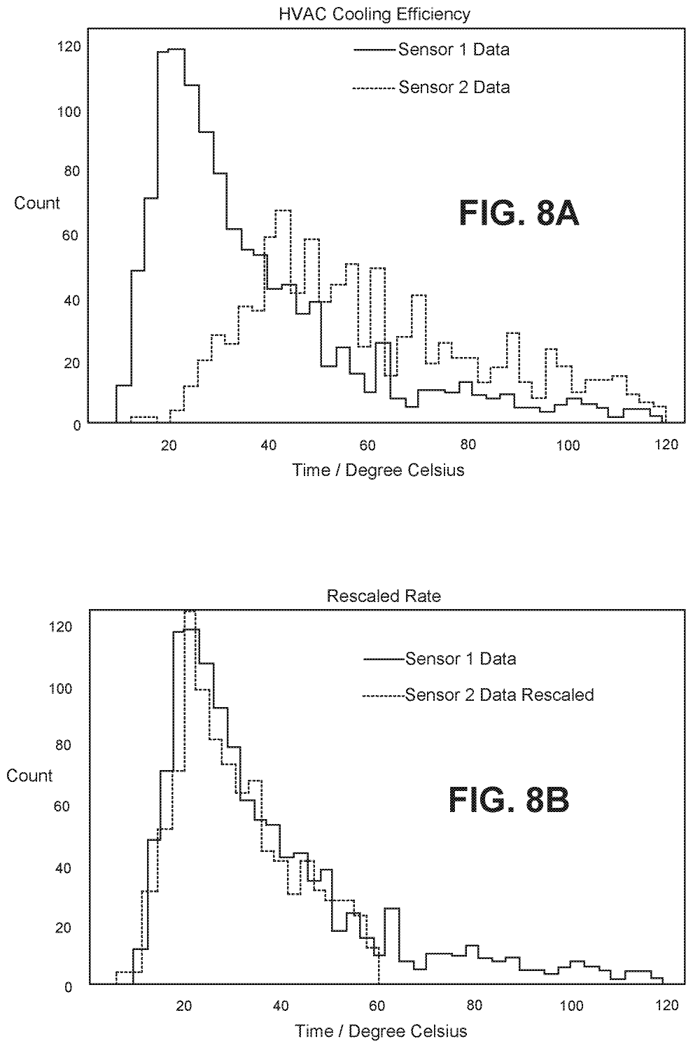

FIGS. 8A-8B illustrate histograms of data collected from two sensor nodes in the same home. As seen in FIG. 8A, Sensor 1 has a lower distribution mean than Sensor 2. Multiplying each value of the time/degree Celsius for Sensor 2 by a factor gives the rescaled results of FIG. 8B. The rescaled distributions of the two curves in FIG. 8B match up quite closely. In some embodiments, rescaling is performed to combine data from different sensor nodes in a residence to provide additional analytical results. For example, rescaled histogram data from different sensor nodes can be pooled together into a single combined histogram, and changes to the statistics of the combined histogram may be used to detect potential HVAC issues.

In general, the change in temperature of a room due to a heat source is given by:

Q=CΔT

Q is the heat from a source, C is the heat capacitance, and ΔT is the change in temperature. With the heat capacitance remaining constant,

$$\frac{dQ}{dt} = C \frac{d Δ T}{dt} . As$$

$$Δ T ( t ) = T ( t ) - T ( t = {t}_{0} ) ,$$

we therefore get:

$$\frac{dQ}{dt} = C \frac{dT}{dt}$$

We separate the heat terms as: Q=Q₁+Qₑ

Q₁ is the source from the system under test, such as the HVAC or PTAC, and Qₑ is the heat flow from other environmental sources, such as the difference in temperature between the room and its surroundings, human presence, and other activities.

$$\frac{dT}{dt} = \frac{1}{C} ( \frac{{dQ}_{1}}{dt} + \frac{{dQ}_{e}}{dt} ) . Setting :$$

$${q}_{1} ( t ) = \frac{1}{C} ( \frac{{dQ}_{1}}{dt} ) and$$

$${q}_{e} ( t ) = \frac{1}{C} ( \frac{{dQ}_{e}}{dt} )$$

In example embodiments, we can take q₁ as a constant in time as we assume the heat flow from an HVAC/PTAC system is constant in time. Note that q₁ is dependent on the velocity of air flow, temperature from the vent, the size of vent (due to the Q₁ term) as well as dependent on the room size (due to the C term).

We therefore get: T=q₁t+∫dt qₑ

Note that the dQₑ/dt term, it is generally about 0 because we are typically in a steady state situation in the time scale of a HVAC cycle, resulting in the derivative of 0. For example, before the HVAC turns on, the temperature of the room is relatively stable over the approximately 10 minute time frame, which is the typical time scale of an HVAC cycle.

Thus we can describe the second term due to an environmental change as a random walk about 0.

σWₜ=∫dt qₑ

The factor σ is a scaling factor and Wₜ is described by the Wiener process. The Wiener process is the continuous versions of the random walk.

What is left is: T(t)=q₁t+σWₜ

We are plotting the time it takes for the temperature to change by 1° C. This is equivalent to the “time of first passage problem,” where we are solving the probability distribution of a 1D Brownian motion particle described by:

$$X ( t ) = vt + σ {W}_{t}$$

As our equation for temperature is equivalent to the 1D Brownian motion equation, solutions to the 1D Brownian motion equation are also valid for our situation.

The probability distribution for the 1D Brownian motion to reach a distance α is given by:

$$f ( t ) = \frac{α}{\sqrt{2 π {σ}^{2} {t}^{3}}} {e}^{- \frac{{( α - vt )}^{2}}{2 {σ}^{2} t}}$$

We can rewrite this as:

$$f ( x ) = \sqrt{\frac{λ}{2 π {x}^{3}}} {e}^{- \frac{{λ ( x - μ )}^{2}}{2 {μ}^{2} x}}$$

$$where μ = α / v$$

$$and λ = {α}^{2} / {α}^{2}$$

This distribution is the Inverse Gaussian Distribution. The Inverse Gaussian Distribution has properties of:

Mean given by: E[x]=μ

and variance given by: Var[x]=μ³/λ

Therefore lambda can be calculated by:

$$λ = {E [ x ]}^{3} / Var [ x ]$$

Note that the mean scales as

$$E [ x ] ∝ {C ( \frac{{dQ}_{1}}{dt} )}^{- 1}$$

So the mean of the distribution is proportional to the heat capacitance of the room and inversely proportional to the rate of heat flow from the system under test.

### Adjustment of Diagnostic Data for Reporting

In some embodiments, methods are implemented to adjust some of the estimated values in order to optimize the quality of our diagnostic data shown to a user.

One element in some of the HVAC data calculations and visualizations analyzed below involves some inverses of derivatives (“ratios”) of particular segments of the temperature time series capturing HVAC operational cycles. This group of parameters includes HERₕₑₐₜ, HER_{cool}, TRRₕₑₐₜ, and TRR_{cool}. Their units may all be minutes per ° C., and in example embodiments they range in value from 0 to 60. Described herein are performance metrics for such parameters.

For the Air Filter Cleanliness method, some embodiments gauge the quality of the aggregate HVAC Operational Time estimates produced by an AI system over the course of the average day. A performance metric—the Operational Time Error Bound—is described in the table below.

| Performance | |
|---|---|
| Metric | Definition |
| Ratio Error | Based on an analysis of a collection of ratio-estimates computed on test examples, the |
| | Ratio Error Bound is defined such that 95% of the time, it is true that the (Estimated |
| | Ratio − Ratio Error Bound) < Actual Ratio < (Estimated Ratio + Ratio Error Bound). To |
| | be specific, when, for example, HERₕₑₐₜ is computed/estimated for a given segment in |
| | the temperature time-series, there is a 95% chance that the actual HERₕₑₐₜ value for lies |
| | within +/− Ratio Error Bound of the estimated HERₕₑₐₜ value. |
| Bound | The Ratio Error Bound value might differ for each ratio type (e.g., HERₕₑₐₜ , HER_{cool} , |
| | TRRₕₑₐₜ , and TRR_{cool} ). |
| | The method used to estimate these Ratios may indicate that the time-series segment is |
| | not suitable to produce an estimate. |
| Operational | Based on an analysis of a collection of HVAC Operational Time estimates, the |
| Time Error | Operational Time Error Bound is defined such that 95% of the time, it is true that the |
| Bound | (Estimated HVAC Operational Time − Operational Time Error Bound) < Actual HVAC |
| | Operational Time < (Estimated HVAC Operational Time + Operational Time Error |
| | Bound) when the period of time over which this estimate is made is at least a day (24 |
| | hours calendar time). |
| | The HVAC Operational Time refers to the operation of the HVAC Air Handler |
| | independent of whether any heating or cooling is occurring. This is because the air filter |
| | cleanliness is determined by air flow, not heating or cooling per se. |

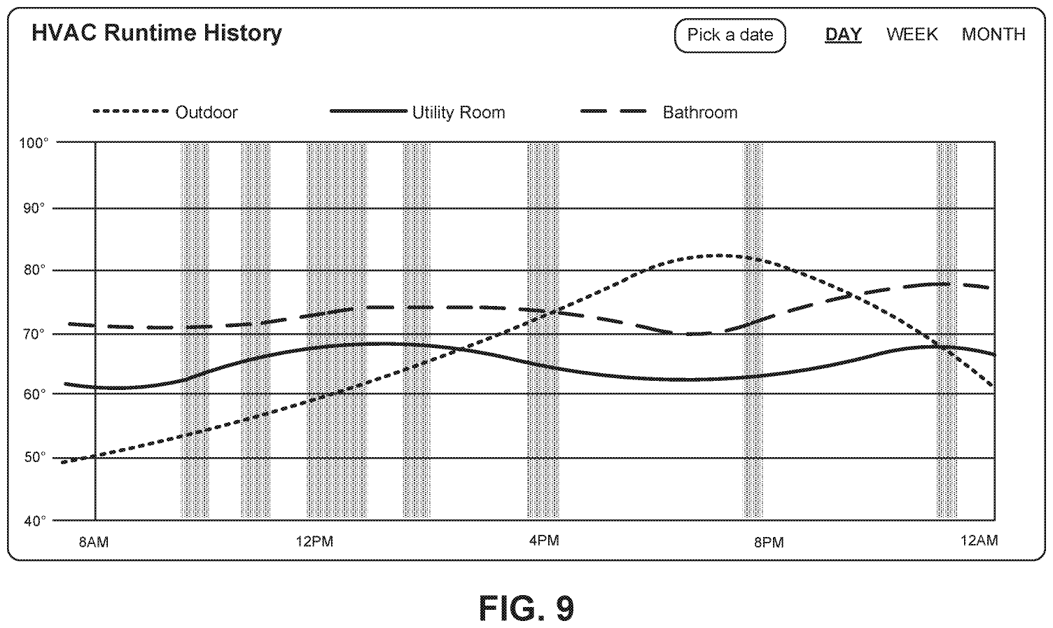

FIG. 9 illustrates an example report of collected data and results of data analysis, which may be displayed in a user interface in some embodiments. In the chart, the temperature reports may be direct readings and not inferences, in which case no adjustment is required. The gray vertical bands on the chart reflect the result of inferences by the system as to intervals during which the HVAC is running. Depending on the AI performance levels, adjustments may be implemented.

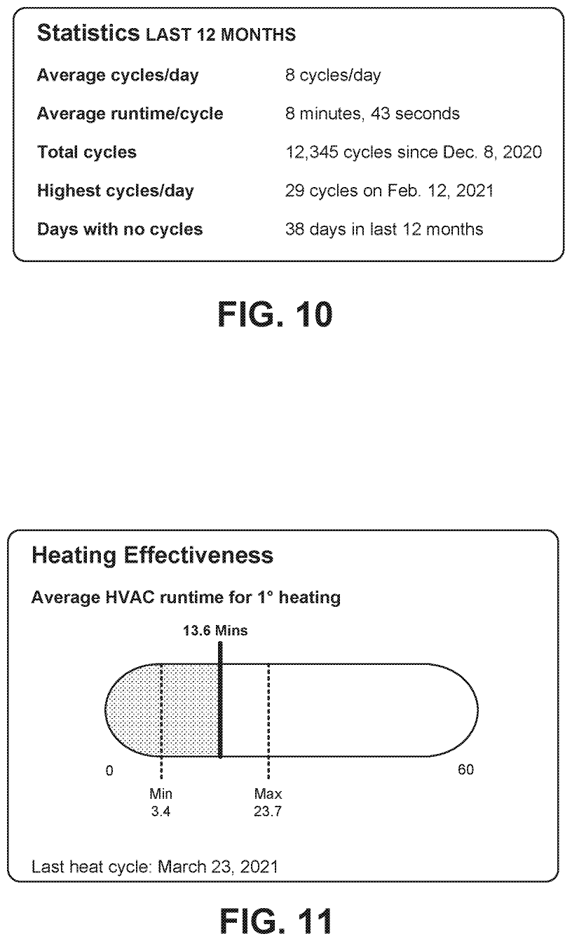

Some embodiments provide data such as that shown in FIG. 10. Such data may be displayed in a user interface.

In some embodiments, the following metrics may be applied to the HVAC On/Off determination along with associated timing. For this table, the focus is on the augmented state of when HVAC is either cooling or heating, rather than if the HVAC air handler is running without heating or cooling.

| | UX Performance | UX Adjustments Depending |
|---|---|---|
| Statistic | Objective | on AI Performance Levels |
| Average | This should be | If (Precision >90%) AND (Recall >90%), the statistic |
| cycles/day | within 10% of the | should stay as is. |
| | actual number. | If (Precision <90%) OR (Recall <90%), this statistic may |
| | | be removed or recast. One example recast if |
| | | (Precision >70%) is this: “Average days this month |
| | | with more than X cycles”; days would qualify if |
| | | (classifier count of cycles > (X/Precision)). |
| Average | This should be | If (Precision >90%) AND (IoU >90%), the statistic should |
| runtime/ | within 10% of the | stay as is. |
| cycle | actual number. | If (Precision <90%) OR (IoU <90%), this statistic should be |
| | | removed or recast. |
| Total cycles | This should be | If (Precision >90%) AND (Recall >90%), the statistic |
| | within 10% of the | should stay as is. |
| | actual number. | If (Precision <90%) OR (Recall <90%), this statistic should |
| | | be removed or recast. One example recast that is totally |
| | | independent of classifier accuracy may be “Longest |
| | | duration when temperature deviated outside the comfort |
| | | zone limit”. |
| Highest | This should be | If (Precision >90%) AND (Recall >90%), the statistic |
| cycles/day | within 10% of the | should stay as is. |
| | actual number. | If (Precision <90%) OR (Recall <90%), this statistic should |
| | | be removed or recast. One possible recast if |
| | | (Precision >70%) is “Over X cycles seen today”; determined |
| | | if (classifier count of cycles > (X/Precision)). |
| Days with no | Included days | If (Precision >90%) AND (Recall >90%), the statistic |
| cycles | should at most have | should stay as is as long as the typical number of cycles per |
| | 1 short cycle. | day is approximately 10 or less. |
| | | If (Precision <90%) OR (Recall <90%) OR (typical number |
| | | of cycles per day >10), this statistic should be removed or |
| | | recast. |

In the above table, the measure “IoU” refers to “intersection over union,” measuring the amount of overlap (intersection) between the predicted state from the classifier and the true state divided by the union of those two (for a particular state). Other measures of performance may alternatively or additionally be used.

In some embodiments, a user interface is provided as shown in FIG. 11.

The following metrics apply to HVAC On/Off determination along with associated timing. For this chart, the focus is on the augmented state of when HVAC is heating, rather than if the HVAC air handler is running without heating.

It may be desirable for the average HVAC Runtime for 1° heating to be within 10% of the right number. It may be desirable for the min and max HVAC Runtimes 1° heating to be protected against outliers. use of median and other percentile operations provides some built-in protection.

In some embodiments, the following are implemented:
For normal operation of the chart, N_{HER} (the number of samples in the collection being analyzed for the displayed Heating Effectiveness) should be >50. This allows for the 5% level to accommodate at least 1 outlier on each end.
If the Ratio Error Bound for HERₕₑₐₜ<10%, the chart should be used as is.
If 10%<Ratio Error Bound for HERₕₑₐₜ<20% across the range, consider two possible actions:
   Remove the Min and Max displays on the chart and just leave the Average (Median) and/or
   Check if Ratio Error Bound is better at one end of the range than the other. In that event, consider adjusting the region of operation so that the Ratio Error Bound is <10%.
If the Ratio Error Bound for HERₕₑₐₜ>20%, suggest raising the required N_{HER} to a higher number (e.g., 200) before displaying the chart at all. Then only show the Average (Median) number. Assuming the estimation of HERₕₑₐₜ is unbiased and the error is symmetrically distributed, the Ratio Error Bound for the computed Average (Median) result should trend downward proportional to the sqrt(N_{HER}). Therefore, the resulting Ratio Error Bound when N_{HER}=200 should be roughly half of what it is when N_{HER}=50.

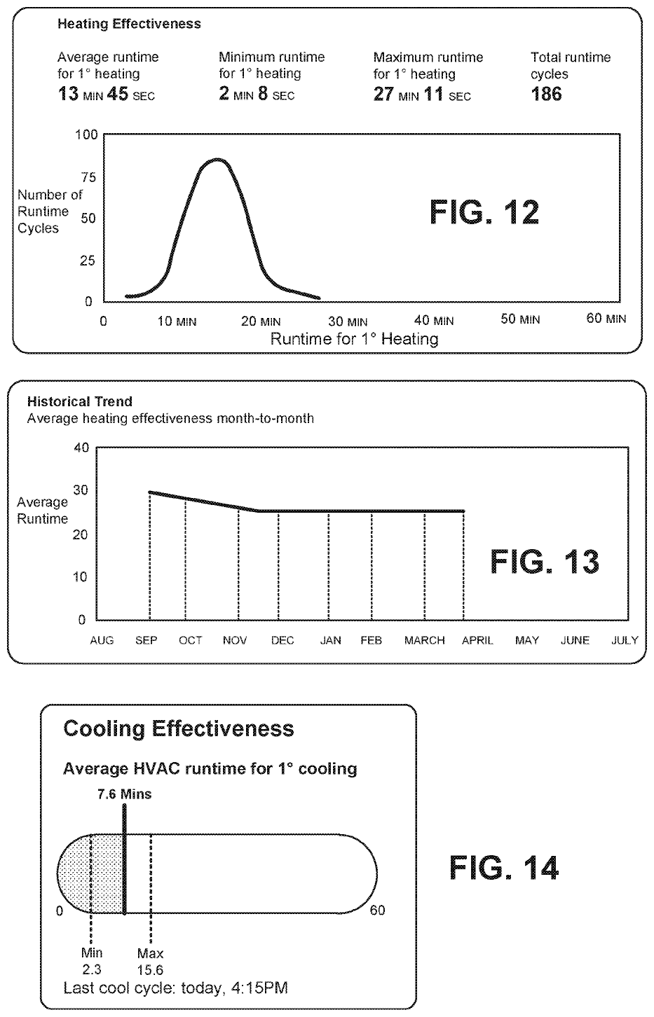

In some embodiments, heating effectiveness is displayed using a chart as shown in FIG. 12. The cycles that are analyzed to compute HERₕₑₐₜ ratios are, in general, a subset of the total detected HVAC cycles. In some embodiments, the method for computing the HERₕₑₐₜ ratios operates to reject that cycle as being unsuitable (too noisy or too weak) to compute the ratios. Therefore, in some embodiments, the following adjustments may be made to the interface:
Change “Total runtime cycles” to “Total cycles analyzed”
Change the vertical axis label to, e.g., “Number of cycles analyzed”.

In addition to the adjustments above, the following may be implemented in some embodiments:
For normal operation of the chart, N_{HER} (the number of samples in the collection being analyzed for the displayed Heating Effectiveness) should be >50. This allows for the 5% level to accommodate at least 1 outlier on each end.
If the Ratio Error Bound for HERₕₑₐₜ<10%, the chart should be used as is.
If 10%<Ratio Error Bound for HERₕₑₐₜ<20% across the range, further actions may be considered:
   Shading the curve to illustrate error bounds around the main curve.
   Check if Ratio Error Bound is better at one end of the range than the other. In that event, consider adjusting the x-axis of the chart so that the Ratio Error Bound is <10% across the chart.
   Adjusting the header/title text to make it clear that only the rough shape is accurate.
If the Ratio Error Bound for HERₕₑₐₜ>20%, the required N_{HER} may be raised to a higher number (say, 200) before displaying the chart at all. In some embodiments, further actions may be used:
   Do not display the extremes on either end—the bottom and top 5%
   Shade the curve to illustrate the error bounds.
   Make the tick marks very coarse or do not label them at all so as to convey only the shape of the distribution and not precise values.
   If the Ratio Error Bound for HERₕₑₐₜ>30%, consider not showing the graph at all.

In some embodiments, a chart such as that of FIG. 13 is provided in a user interface. This screen plots the average (median) HERₕₑₐₜ over the period of interest.

In some embodiments, cooling effectiveness is provided in a user interface as illustrated in FIG. 14.

The following metrics apply to HVAC On/Off determination along with timing associated with that. This chart focuses on the augmented state of when HVAC is cooling, rather than when the HVAC air handler is running without cooling.

It is desirable for the average HVAC Runtime for 1° cooling to be within 10% of the right number. It is desirable the min and max HVAC Runtimes 1° heating to be protected against outliers. The use of median and other percentile operations provides some built-in protection. In some embodiments, the following are implemented:
For normal operation of the chart, N_{HER} (the number of samples in the collection being analyzed for the displayed Cooling Effectiveness) should be >50. This allows for the 5% level to accommodate at least 1 outlier on each end.
If the Ratio Error Bound for HER_{cool}<10%, the chart should be used as is.
If 10%<Ratio Error Bound for HER_{cool}<20% across the range, consider two possible actions:
   Remove the Min and Max displays on the chart and just leave the Average (Median) and/or
   Check if Ratio Error Bound is better at one end of the range than the other. In that event, consider adjusting the region of operation so that the Ratio Error Bound is <10%.
If the Ratio Error Bound for HER_{cool}>20%, suggest raising the required N_{HER} to a higher number (say, 200) before displaying the chart at all. Then only show the Average (Median) number. Assuming the estimation of HER_{cool} is unbiased and the error is symmetrically distributed, the Ratio Error Bound for the computed Average (Median) result should trend downward proportional to the sqrt(N_{HER}). Therefore, the resulting Ratio Error Bound when N_{HER}=200 should be roughly half of what it is when N_{HER}=50.

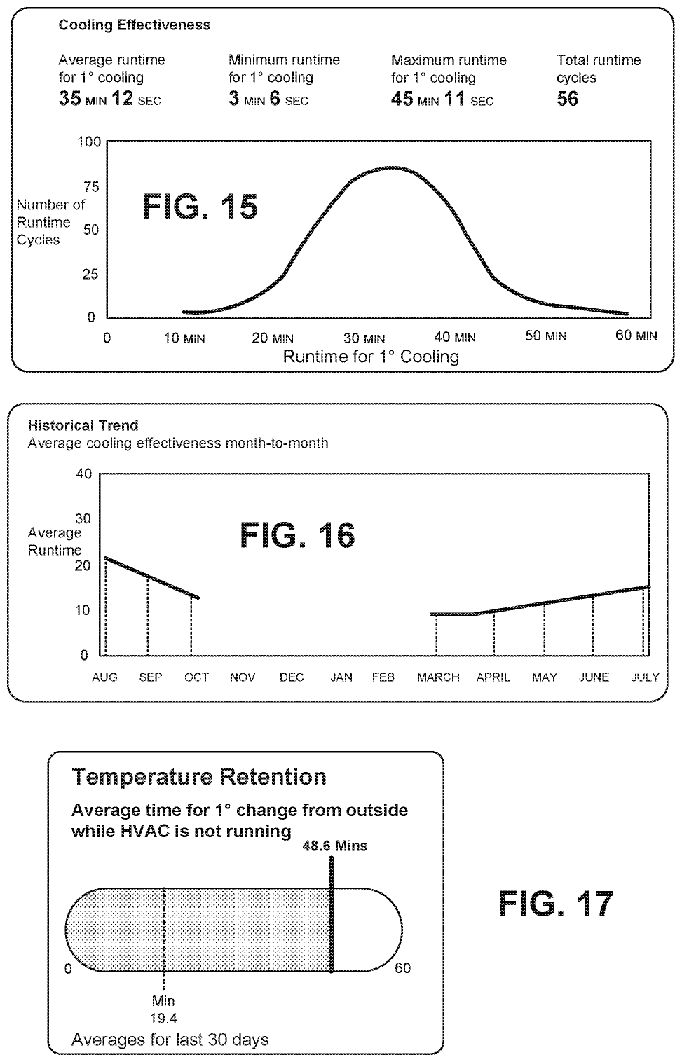

In some embodiments, cooling effectiveness information is provided in a user interface as shown in FIG. 15. The cycles that are analyzed to compute HER_{cool} ratios are, in general, a subset of the total detected HVAC cycles. The method for computing the HER_{cool} ratios may operate to reject that cycle as being unsuitable (too noisy or too weak) to compute the ratios. Therefore, the following adjustments to this UX screen may be implemented in some embodiments:
Change “Total runtime cycles” to “Total cycles analyzed” or something to that effect.
Change the vertical axis label to “Number of cycles analyzed”.

In addition to the adjustments above, the following set of adjustment guidelines may be implemented in some embodiments:
For normal operation of the chart, N_{HER} (the number of samples in the collection being analyzed for the displayed Cooling Effectiveness) should be >50. This allows for the 5% level to accommodate at least 1 outlier on each end.
If the Ratio Error Bound for HER_{cool}<10%, the chart may be used as is.
If 10%<Ratio Error Bound for HER_{cool}<20% across the range, consider three possible actions:
   Shading the curve to illustrate error bounds around the main curve
   Check if Ratio Error Bound is better at one end of the range than the other. In that event, consider adjusting the x-axis of the chart so that the Ratio Error Bound is <10% across the chart.
   Adjusting the header/title text to make it clear that only the rough shape is accurate.
If the Ratio Error Bound for HER_{cool}>20%, suggest raising the required N_{HER} to a higher number (say, 200) before displaying the chart at all. Also, consider four possible additional actions:
   Do not plot the extremes on either end—the bottom and top 5%
   Shade the curve to illustrate the error bounds.
   Make the tick marks very coarse or do not label them at all so as to convey the shape of the distribution and not precise values.
   If the Ratio Error Bound for HER_{cool}>30%, possibly refrain from showing the graph at all.

In some embodiments, cooling effectiveness trend data may be provided in a user interface using a chart such as that of FIG. 16. This screen plots the average (or the median in some embodiments) HER_{cool} over the period of interest.

In some embodiments, temperature retention data may be provided in a user interface using a chart such as that of FIG. 17.

The following metrics apply to HVAC “Off” determination along with timing associated with that. For this chart, the focus is on the augmented state of when HVAC is neither cooling nor heating. If the HVAC air handler is running without cooling or heating, that counts as HVAC “Off” in example embodiments.

For a given outdoor to indoor temperature difference and house configuration (apart from considering solar and wind effects), it is desirable for the average Temperature Retention Rate (TRR) (or time for 1° change) to be within 10% of the right number. It is desirable for the min TRR to be protected against outliers. The use of median and other percentile operations provides some built-in protection.

In some embodiments, the following may be implemented:
For normal operation of the chart, N_{TRR} (the number of samples in the collection being analyzed for the displayed Temperature Retention) should be >50. This allows for the 5% level to accommodate at least 1 outlier on each end.
If the Ratio Error Bound for TRR_{cool} (or TRRₕₑₐₜ)<10%, the chart should be used as is.
If 10%<Ratio Error Bound for TRR_{cool} (or TRRₕₑₐₜ)<20% across the range, consider two possible actions:
   Remove the Min displays on the chart and just leave the Average (Median) and/or
   Check if Ratio Error Bound is better at one end of the range than the other. In that event, consider adjusting the region of operation so that the Ratio Error Bound is <10%.
If the Ratio Error Bound for TRR_{cool} (or TRRₕₑₐₜ)>20%, suggest raising the desired N_{TRR} to a higher number (say, 200) before displaying the chart at all. Then only show the Average (Median) number. Assuming the estimation of TRR_{cool} is unbiased and the error is symmetrically distributed, the Ratio Error Bound for the computed Average (Median) result should trend downward proportional to the sqrt(N_{TRR}). Therefore, the resulting Ratio Error Bound when N_{TRR}=200 should be roughly half of what it is when N_{TRR}=50.

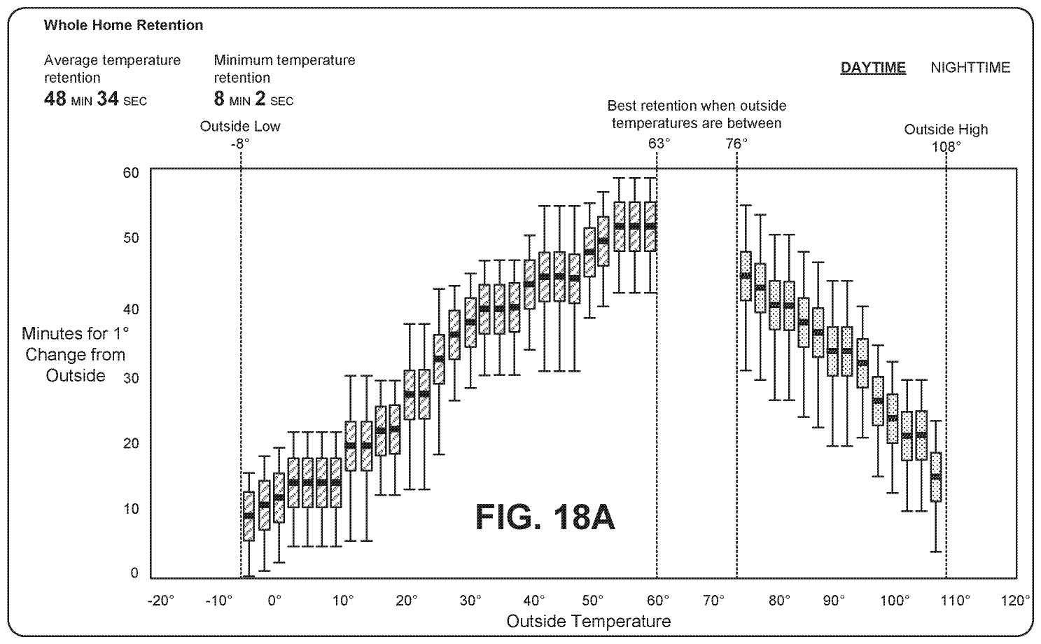

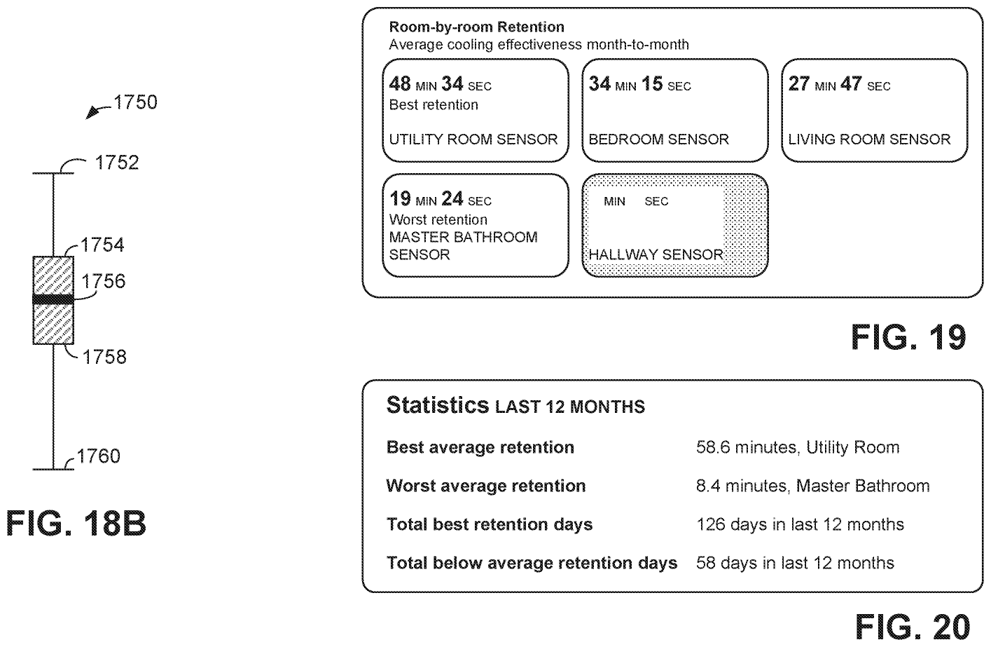

In some embodiments, temperature retention information is provided in a user interface as shown in FIG. 18A. In some embodiments, the slope and offset of the mean/median/mode or other value may be compared between different time periods, different rooms, and/or different dwellings to compare temperature retention.

The cycles that are analyzed to compute TRR_{cool} and TRRₕₑₐₜ ratios are, in general, a subset of the total detected HVAC cycles. The algorithm computing the TRR_{cool} and TRRₕₑₐₜ ratios may operate to reject that cycle as being unsuitable (too noisy or too weak) to compute the ratios. The following adjustments to the user interface may be implemented:
For normal operation of the chart, N_{TRR} (the number of samples in the collection being analyzed for a particular box-and-whiskers element) should be >50. This allows for the 5% level to accommodate at least 1 outlier on each end.
If 15<N_{TRR}<50, the whiskers portion of the display may be omitted for that element and just display the main box section for that slice of outdoor temperatures. If N_{TRR}<15, leave the box blank. Note that this determination may be done separately for every potential box and whiskers element. Therefore it follows that some elements will be blank, some will just have the main box section and some will be full box-and-whiskers elements.
If the Ratio Error Bound for TRR_{cool} (and TRRₕₑₐₜ)<10%, the chart may be used as is.
If 10%<Ratio Error Bound for TRR_{cool} (and TRRₕₑₐₜ)<20% across the range, consider three possible actions:
   Leave the whiskers off entirely and consider fuzzing/widening the line width of the bottom and top of the box section.
   Check if Ratio Error Bound is better at one end of the time range than the other. In that event, consider adjusting the y-axis of the chart so that the Ratio Error Bound is <10% across the chart.
   Adjusting the header/title text to make it clear that only the rough shape is accurate.
If the Ratio Error Bound for TRR_{cool} (and TRRₕₑₐₜ)>20%, suggest raising the required N_{TRR} to a higher number (say, 200) before displaying the box and whiskers element at all. Also, consider four possible additional actions:
   Leave off the whiskers
   Fuzz or widen the bottom and top lines of the box element.
   If the Ratio Error Bound for TRR_{cool} (and TRRₕₑₐₜ)>30%, consider not showing the graph at all.

In some embodiments, room-by-room retention information is provided in a user interface as shown in FIG. 19. Since the N_{TRR} will vary by sensor node (since the quality of the estimate can vary based on different conditions of a room), it is possible that the user interface features described above will suggest showing data for some rooms and not others. Some embodiments operate to gray out the sensor node elements with too little data to be confident of the numbers. That way the chart would “show” all the rooms, but some would still be in “data gathering” or “measuring” phase.

In some embodiments, temperature retention statistical information is provided in a user interface as shown in FIG. 20. Information regarding the number of “best retention days” may be used to indicate the number of days (e.g. in the last twelve months) during which it took 60 minutes or more for a one degree change in temperature. Information regarding the “total below average retention days” may be used to indicate the number of days (e.g. in the last twelve months) on which retention was below the average year-to-date retention.

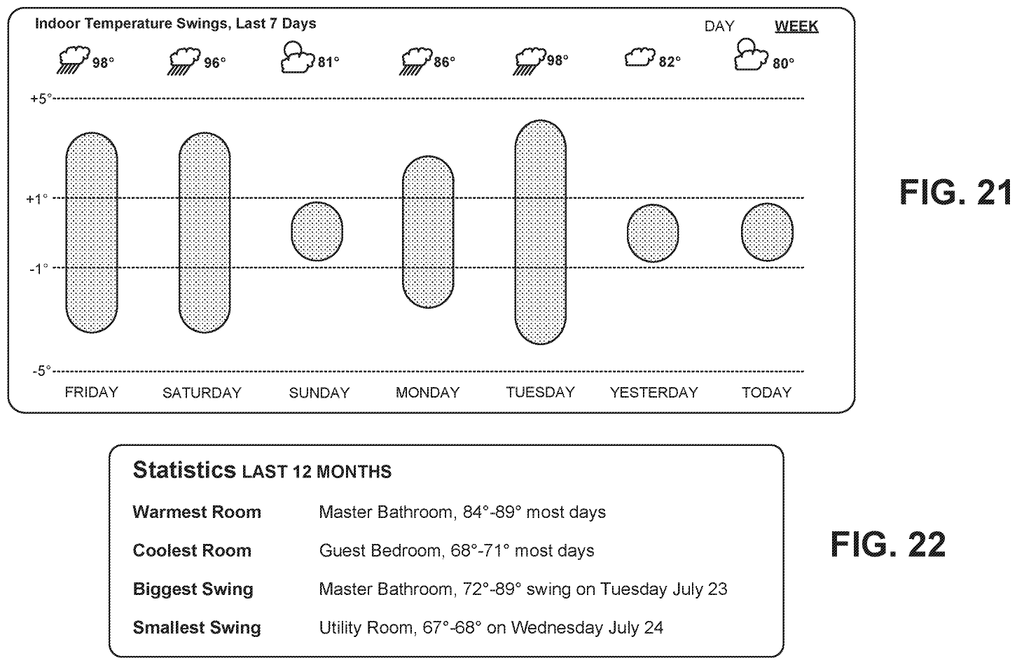

In some embodiments, temperature swing information is provided in a user interface as shown in FIG. 21.

In some embodiments, temperature swing statistics are provided in a user interface as shown in FIG. 22.

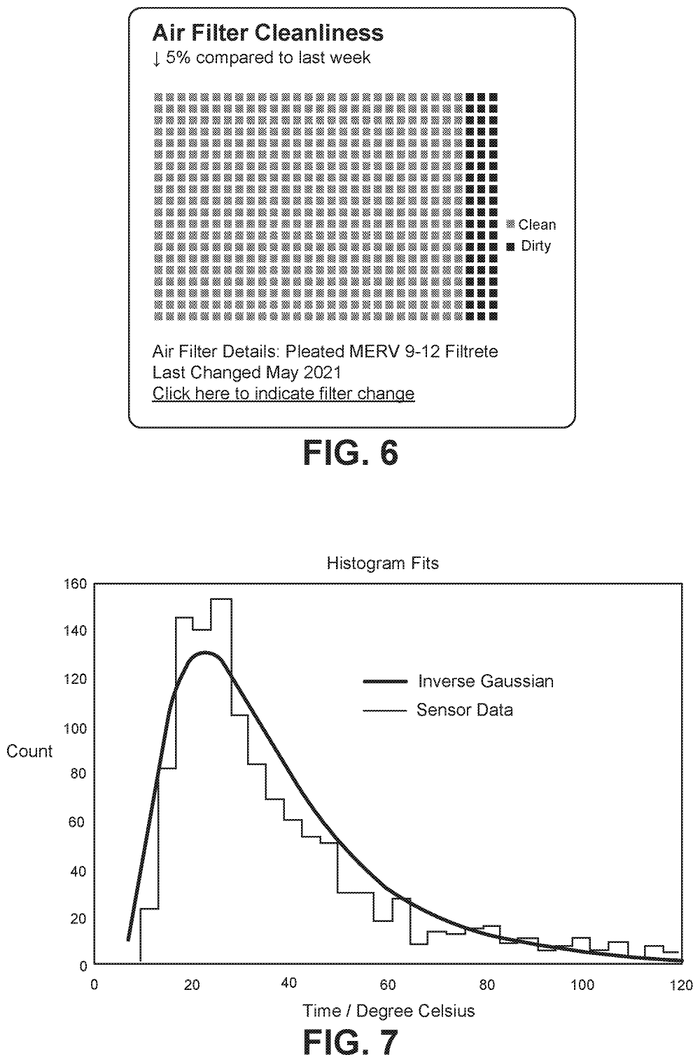

In some embodiments, air filter cleanliness information is provided in a user interface as shown in FIG. 6. The interfaced reflects determination of the HVAC Operational Time. In this case, the relevant time is when the Air Handler runs whether or not heating or cooling is happening. The air filter collects more dirt when the air is flowing through it, and it does not matter if the system is actively heating or cooling the house.

It is desirable for the level of cleanliness reported to be within 20% of the actual state. Assuming the operational time model is correct, this means that the HVAC Operational Time should be within roughly 15% of the actual value. (Note that the nonlinear nature of the equation magnifies the impact of errors near the end of the filter's anticipated life. Here we use 40000 minutes to determine the error bound.)

In some embodiments, the following are implemented:
If HVAC Operational Time Error Bound<(15% of average daily HVAC Operational Time), no changes to the screen are suggested.
If (15% of average daily HVAC Operational time)<HVAC Operational Time Error Bound<(25% of average daily HVAC Operational time), reduce the granularity of the display (e.g., reducing the number of “dots” in the air filter that indicate its dirtiness level).
If HVAC Operational Time Error Bound>(25% of average daily HVAC Operational Time), consider two possible adjustments:
   Adjust algorithm to weight calendar time more heavily than operational time in computing the level of dirtiness.
   Remove the sub-heading item about changes week to week in amount of dirtiness that week.

### Reporting HVAC Effectiveness

Some embodiments provide information regarding HVAC effectiveness. In the following description, values used include HERheat[ci], HERcool[ci], TRRheat[ci], and TRRcool[ci] for each HVAC cycle ci. These values may be computed on a hub device based on data collected by one or more sensor node devices.

In the case of HER values, this is an inverse slope measurement on the temperature trend measured by a given sensor node during the portion of the HVAC cycle when the system is On (either heating or cooling). The units for HER may be minutes per degree Celsius, although other units may be used in other embodiments.

In the case of TRR values, this is an inverse slope measurement on the temperature trend measured by a given sensor node during the portion of the HVAC cycle when the system is Off (either heating or cooling). The units for TRR may be minutes per degree Celsius, although other units may be used in other embodiments.

This following describes the calculations used in presenting data regarding HVAC effectiveness in a user interface.

The methods detailed below for computing HVAC Effectiveness, Heating Effectiveness, Cooling Effectiveness, Temperature Retention and Temperature Swings all have an implicit perspective. Each sensor node offers a different observation point, a different perspective, on those parameters. This is perhaps easiest to understand with temperature swings that vary from room to room because, in part, the Temperature Retention varies room to room. But the system-level HVAC Effectiveness also varies room to room because, in part, the venting and air flow is different in each room. Some embodiments present to the user the median of all the calculated effectiveness ratings for the home. Some embodiments present to the user the worst calculated effectiveness ratings for the home.

Data used in determining HVAC effectiveness may be calculated using a method such as the following. The following steps may be repeated.
On the completion of every HVAC On Cycle, an HVAC Effectiveness Rate is calculated and stored for either heating or cooling depending on which mode the HVAC is operating.
On the completion of every HVAC Off Cycle the Thermal Retention Rate is calculated and stored for either heating or cooling depending on whether the outdoor temperature is greater than or less than the indoor temperature. In the case that an HVAC Off Cycle lasts for more than a threshold amount of time (e.g. two hours), the Thermal Retention Rate may also be calculated and stored. Note that in many of those cases, the TRR will be greater than 60.

The table below gives descriptions for a method for calculated HER's and TRR's using single point temperature values at the edges of an HVAC On or Off cycle respectively.

In some embodiments, a more refined estimation method of the HER's and TRR's may be performed. For example, the method may include taking the slope of a spline fit or using a smoothed derivative function, exponential decay function or something similar. A hub device may perform the calculation along with determining whether the cycle is heating or cooling and then send those results to a cloud service for processing.

In some embodiments, in cases for which HER's and/or TRR's are difficult to estimate/measure, the hub device may report such difficulty to the cloud service. The cloud service may ignore those data points in providing the user interface display.

In some embodiments, an initial determination is made of whether the HVAC is in an “on” state or an “off” state based on, for example, sounds detected (or not detected) by a sensor node, and a subsequent determination is made of whether the HVAC is heating or cooling (or merely circulating air) based on a change (or lack of change) in temperature detected by the sensor node during the “on” state. Example parameters used to present information are listed in the following table.

| Symbol | Parameter | Description |
|---|---|---|
| cst | The “cycle start time” of the HVAC | The time when the HVAC began an On or |
| | or Thermal event in question. | Off cycle. |
| cet | The “cycle end time” of the HVAC | The time when the HVAC ended and On or |
| | or Thermal event in question. | Off cycle. |
| Tₛ | The starting indoor temperature | The indoor temperature at time cst. |
| | when the cycle began (at cst). | |
| Tₑ | The ending indoor temperature | The indoor temperature at time cet. |
| | when the cycle ended (at cet) | |
| ci | An internal index counter (“cycle | A basic cycle index to aid in algorithm |
| | index”) that increments for every | description here. This particular variable |
| | cycle that is stored in the database | is not explicitly required and other |
| | for processing later. | implementations are possible (such as a |
| | | timestamp index). |
| HERₕₑₐₜ | The HVAC Effectiveness Rate | For the HVAC On heating cycle of interest, |
| | in a heating cycle. Units are | this is the time it took to raise the indoor |
| | minutes/° C. | temperature by 1° C. It is calculated as |
| | | (cet − cst)/ abs(Tₑ − Tₛ). Units are minutes/° C. |
| HERₕₑₐₜ[ci] | The HERₕₑₐₜ for cycle ci. | The HERₕₑₐₜ for cycle ci. |
| HER_{cool} | The HVAC Effectiveness Rate | For the HVAC On cooling cycle of interest, |
| | in a cooling cycle. Units are | this is the time it took to lower the indoor |
| | minutes/° C. | temperature by 1° C. It is calculated as |
| | | (cet − cst)/abs(Tₑ − Tₛ). Units are minutes/° C. |
| HER_{cool}[ci] | The HER_{cool} for cycle ci. | The HER_{cool} for cycle ci. |
| TRRₕₑₐₜ | The Thermal Retention Rate | For the HVAC Off heating cycle of interest, |
| | when the HVAC is nominally | this is the time it took for the indoor temperature |
| | in a heating mode. | to fall by 1° C. It is calculated as (cet − cst)/ |
| | Units are minutes/° C. | abs(Tₑ − Tₛ) . Units are minutes/° C. |
| TRRₕₑₐₜ[ci] | The TRRₕₑₐₜ for cycle ci. | The TRRₕₑₐₜ for cycle ci. |
| TRR_{cool} | The Thermal Retention Rate | For the HVAC Off heating cycle of interest, |
| | when the HVAC is nominally | this is the time it took for the indoor temperature |
| | in a cooling mode. | to rise by 1° C. It is calculated as (cet − cst)/ |
| | Units are minutes/° C. | abs(Tₑ − Tₛ). Units are minutes/° C. |
| TRR_{cool}[ci] | The TRR_{cool} for cycle ci. | The TRR_{cool} for cycle ci. |
| P5(.) | A percentile operator which | A percentile operator which selects the value |
| | selects the value which is greater | which is greater than 5% of the list of candidate |
| | than 5% of the | values. This is used as a more robust form of |
| | list of candidate values. | the min or minimum operator. |
| P95(.) | A percentile operator which | A percentile operator which selects the value |
| | selects the value which is greater | which is greater than 95% of the list of candidate |
| | than 95% of the | values. This is used as a more robust form of |
| | list of candidate values. | the max or maximum operator. |

In some embodiments, heating effectiveness information is provided in a user interface as shown in FIG. 11. Elements used for this display are given in the following table.

| Item | How to Calculate |
|---|---|
| Average (Median) HVAC | median(HERₕₑₐₜ[ci] for all ci in the 30 day |
| Runtime for 1° Heating | interval of interest) |
| Minimum HVAC Runtime | P5(HERₕₑₐₜ[ci] for all ci in the 30 day |
| for 1° Heating | interval of interest) |
| Maximum HVAC Runtime | P95(HERₕₑₐₜ[ci] for all ci in the 30 day |
| for 1° Heating | interval of interest) |

In some embodiments, heating effectiveness information is provided in a user interface as shown in FIG. 12. This is plot of the entire list of HERₕₑₐₜ[ci] values for the time interval of interest (e.g., last 30 days). The statistic values shown were described above, except for the “Total runtime cycles” which is a count of the HERₕₑₐₜ[ci] entries plotted.

In some embodiments, heating effectiveness information is provided in a user interface as shown in FIG. 13. This is a plot of the median(HERₕₑₐₜ[ci]) for each month over the interval of interest (e.g., the last 12 months).

In some embodiments, cooling effectiveness information is provided in a user interface as shown in FIG. 14. Elements used for this display are given in the following table.

| Item | How to Calculate |
|---|---|
| Average (Median) HVAC | median(HER_{cool}[ci] for all ci in the 30 |
| Runtime for 1° Cooling | day interval of interest) |
| Minimum HVAC Runtime | P5(HER_{cool}[ci] for all ci in the 30 |
| for 1° Cooling | day interval of interest) |
| Maximum HVAC Runtime | P95(HER_{cool}[ci] for all ci in the 30 |
| for 1° Cooling | day interval of interest) |

In some embodiments, cooling effectiveness information is provided in a user interface as shown in FIG. 15. This is plot of the entire list of HER_{cool}[ci] values for the time interval of interest (e.g., last 30 days). The statistic values shown were defined in the prior section except for the “Total runtime cycles” which is a count of the HER_{cool}[ci] entries plotted.

In some embodiments, cooling effectiveness information is provided in a user interface as shown in FIG. 16. This is a plot of the median(HER_{cool}[ci]) for each month over the interval of interest (e.g., the last 12 months). The gap in the plot is because during the winter months there were no HVAC cooling cycles.

In some embodiments, temperature retention information is provided in a user interface as shown in FIG. 17. Parameters used for this display are described in the following table.

| Item | How to Calculate |
|---|---|
| Average (Median) time for | median(TRR_{cool}[ci], TRRₕₑₐₜ[ci], for |
| 1° Change (when HVAC Off) | all ci in the 30 day interval of interest) |
| Minimum time for 1° Change | P5(TRR_{cool}[ci], TRRₕₑₐₜ[ci] for all ci |
| (when HVAC Off) | in the 30 day interval of interest) |

Note that there is no maximum time shown on the summary since it will often be off scale.

In some embodiments, temperature retention information is provided in a user interface as shown in FIG. 18A. This is plot of the box and whiskers processing of the entire list of TRR_{cool}[ci] and TRRₕₑₐₜ[ci] values for the time interval of interest (e.g., last 30 days). Note that for the plot, the calculations for heating and cooling are separated into the orange and blue lines respectively. Also note that they are plotted against the outside temperature applicable for each cycle of interest.

In this example there is a separate plot for Daytime and Nighttime. In the example figure above, the selection is indicated in the upper right as a Daytime plot. There are two reasons Daytime and Nighttime are shown in different plots. First, users tend to configure their home differently at nighttime by, for example, closing the blinds or drapes. This changes the thermal retention properties of the home. Second, sunlight can affect the apparent thermal retention during certain hours of the daytime but, of course, nighttime by definition has no sunlight.

In some embodiments, the sunrise and sunset times noted in weather data (which may be retrieved over a network) is used to separate Daytime and Nighttime for the calculations. Cases where the HVAC Off duration spans the boundary between Day and Night by less than 1 hour (or some other predefined duration) may be put in the category it was in longest. For example, if a given HVAC Off cycle spent 50% of its time or more in Daytime, put it in Daytime; otherwise put it in Nighttime. For cases, when the HVAC Off duration extend more than 1 hour in both categories, count it in both categories and count this for internal purposes.

The Box and Whiskers Figure Element of FIG. 18A may be understood as follows, with reference to FIG. 18B. FIG. 18B illustrates a graphical display element 1750 used to display results in some embodiments. In some embodiments, upper whisker 1752 illustrates 95th percentile value, upper box edge 1754 illustrates an upper quartile value, band 1756 illustrates a median value, lower box edge 1758 illustrates a lower quartile value, and lower whisker 1760 illustrates a 5th percentile value. Different percentile values may be used in different embodiments, and different graphical display elements may be used in different embodiments. The figure element values may be used as described in the following table. (The cooling case is described explicitly; the heating case follows the same process but uses the TRRₕₑₐₜ[ci] values instead of the TRR_{cool}[ci] values.)

| Element | Formula | Comment |
|---|---|---|
| Lower | P5(TRR_{cool}[ci] for all ci in the 30 | The 5th percentile value is used |
| Whisker | day range of interest where the | here rather than minimum to |
| | outdoor temperature is in range | screen out potential outliers. |
| | for this element) | |
| Lower | P25(TRR_{cool}[ci] for all ci in the 30 | 25% of the TRR values are less |
| Quartile | day range of interest where the | than this. |
| | outdoor temperature is in range | |
| | for this element) | |
| Median | P50(TRR_{cool}[ci] for all ci in the 30 | Median of the TRR values. |
| | day range of interest where the | |
| | foutdoor temperature is in range | |
| | or this element) | |
| Upper | P75(TRR_{cool}[ci] for all ci in the 30 | 75% of the TRR values are less |
| Quartile | day range of interest where the | than this. |
| | outdoor temperature is in range | |
| | for this element) | |
| Upper | P95(TRR_{cool}[ci] for all ci in the 30 | The 95th percentile value is |
| Whisker | day range of interest where the | used here rather than maximum |
| | outdoor temperature is in range | to screen out potential outliers. |
| | for this element) | |

In the Temperature Retention plot of FIG. 18A, the lower values are nearer the bottom of the plot and the upper values are nearer the top. The temperature range for each Box and Whiskers computation is 2.5°. In some embodiments, even where calculations are performed using e.g. Celsius units, the display may be in Fahrenheit units to accommodate user preferences or local conventions.

In some embodiments, when an HVAC Off cycle crosses the boundary from one outdoor temperature range into another, it may be split for the purposes of this graph. The TRR may be calculated for each outdoor temperature range separately.

In some embodiments, room-by-room temperature retention information is provided in a user interface as shown in FIG. 19. What is shown for each sensor node in figure is the Average (Median) Temperature Retention time for that room for the period covered in the graph of FIG. 18A.

In some embodiments, temperature retention statistics are provided in a user interface as shown in FIG. 20. In some embodiments, the TRR_{cool}[ci] and TRRₕₑₐₜ[ci] are considered together, as one bundle when analyzing the stats. Losing 1 degree C. in 10 minutes in the winter is bundled in with gaining 1 degree C. in 10 minutes in the summer.

In some embodiments, temperature swing information is provided in a user interface as shown in FIG. 21. For the period shown, the following guidelines may be used:
The minimum temperature shown for each day is the lowest indoor temperature detected by any sensor node in the house that day.
The maximum temperature shown for each day is the highest indoor temperature detected by any sensor node in the house that day.
Given the above, the full temperature swing of the house for each day goes from the lowest temperature measured by any sensor node in the house that day to the highest temperature measured by any sensor node in the house that day. The lowest and highest temperatures for a particular day may not be from the same sensor node.

In some embodiments, temperature swing information is provided in a user interface as shown in FIG. 22. In contrast with the summary Temperature Swing chart of FIG. 21, for the statistics here, each sensor node is considered separately. The “Biggest swing” entry is identifying the sensor node that experiences the greatest swing in temperature (e.g. from low to high) during the day.

### Expansion of HVAC Monitoring Methods

Described herein is an example method of modeling the system across multiple zones. While most smaller homes have just one HVAC system, it is relatively common for larger homes to have more than one HVAC system. Furthermore, some apartments use room-based PTACs (packaged terminal air conditioners) which effectively make them multi-zone residences. Example embodiments account for multi-zone operation.

In the development of a thermal model of the home there are multiple choices to be made regarding the structure and the type of model to be used. One approach is a physical model that is directly based on first principles from heat transfer. Such a model uses known thermal conductivity values that describe the building in which the sensor nodes are placed. Another approach is black-box model which utilizes the data to train a neural network to model the thermal properties of the house. A black-box model maybe accurate but it is difficult to interpret it to find the values of interest. A physical model requires information about the environment that may not be available, and thus using it would thus require many assumptions. Example embodiments use a hybrid approach which may be described as a grey-box model. A grey-box thermal model combines information about the system from physics with system identification methods to model the system accurately while preserving the meaning of the data. The details of an example model used in some embodiments are given below.

An example analysis uses an analogy between heat and charge to create an electric circuit that models the flow of heat with in a multizone building. In this model, each zone is modeled as a capacitor connected to ground. The flow of heat between zones is modeled as the flow of charge from one zone to another through a resistor. The flow of heat into the building due to energy from the sun and temperature difference with the outdoors is modeled using a voltage source and a current source that are connected to the zones through resistors as well.

Node analysis gives the equation below for the temperature in a given zone:

$$\text{?} = \{ \begin{matrix}{k}_{n 1} ( {T}_{n} - {T}_{1} ) \text{?} {k}_{( n - 1 )} \text{?} ( {T}_{n - 1} - {T}_{1} ) + … + {k}_{21} ( {T}_{2} - {T}_{1} ) & HVAC Off \\ {k}_{n 1} ( {T}_{n} - {T}_{1} ) \text{?} {k}_{( n - 1 )} \text{?} ( {T}_{n - 1} - {T}_{1} ) + … + {k}_{21} ( {T}_{2} - {T}_{1} ) + \frac{\text{?}}{\text{?}} & HVAC On\end{matrix}$$

$$\text{?} \text{indicates text missing or illegible when filed}$$

At any moment in time, the multizone building will be in one of four states given below. In each of these states we will perform calculations and store the results to be used in the other states. Since this the states some states depend on data from other states, full calculations may be performed after the building has gone through all states which should take at most a full day.
1. HVAC OFF, SUN OFF:
   1. During this state the System has no energy input and so the k values can be determined.
   2. This yields a system of n equations, one for each zone. To calculate the values of interest we solve the system of equations described above. During a period of time there will be many measurements and statistical methods can be used to aggregate the data.
2. HVAC ON, SUN OFF
   1. During this state the k values stored can be used to solve for the HVAC output for a given zone.
3. HVAC OFF, SUN ON
   1. During this state the k values stored can be used to solve for the Sun Input for a given zone.
4. HVAC ON, SUN ON
   1. During this state the HVAC Input into the system can be calculated using stored k values and stored sun input values.

The K Values will be the thermal will be the product of the thermal conductivity of the wall between two zones and 1/C, where C is the thermal capacitance of the zone.

In some embodiments, the following assumptions may be used:
Sun Radiation Energy does not vary greatly over 15 min periods.
K Values do not vary greatly during daytime

In some embodiments, Thermal Conductivity K values are found using previous data. Each sensor node may be treated as a zone. In some embodiments, no assumptions about the relationship of the zones to each other are made. The Outside Environment is treated as a zone.

Such embodiments generalize more easily rather than a hardcoded estimate of k values. Such embodiments update to reflect variations in thermal resistivity values due to weather conditions. Example embodiments operate to provide useful information without requiring information on the relative locations of the sensor nodes. It may be assumed that all zones are adjacent, such that dT/dt for each zone in an n-zone home may be assumed to be the sum.

### Thermal Model, First Order Approximation

An example of thermodynamic method used to model the change in temperature over time as the HVAC system turns on and off is described here.

In some embodiments, it may be assumed that the only q source is from the HVAC system. Sources such as solar, human presence and other heating/cooling sources are absorbed into k. The single zone thermal model gives

$$dT / dt = k ( t ) ( {T}_{o} - {T}_{i} ) + q ( t )$$

where Tᵢ is the indoor temperature, Tₒ is the outdoor temperature, and q is the rate of heat added/removed by the HVAC system.

Performing a Taylor expansion,

$${T}_{i} ( t ) = {T}_{i} ( t = {t}_{o} ) + {T}_{i}^{′} ( t - {t}_{o} ) + higher - order terms$$

$${T}_{o} ( t ) = {T}_{o} ( t - {t}_{o} ) + {T}_{o}^{′} ( t - {t}_{o} ) + higher - order terms$$

$$Giving$$

$$dT ( t ) / dt = {T}^{′} = k ( {T}_{o} ( t = {t}_{o} ) + {T}_{o}^{′} ( t - {t}_{o} ) {T}_{i} ( t = {t}_{o} ) - {T}_{i}^{′} ( t - {t}_{o} ) ) + q ( t ) + higher - order terms$$

In the limit of Tₒ′ (t−tₒ)<<Tₒ(t=tₒ) and Tᵢ′ (t−tₒ)<<Tᵢ(t=tₒ), we can further approximate with:

$${T}_{i}^{′} = k ( {T}_{o} ( t = {t}_{o} ) - {T}_{i} ( t = {t}_{o} ) ) + q ( t ) + higher - order terms$$

$$With$$

$${T}_{i}^{′} = ( {T}_{i} ( t = {t}_{1} ) - {T}_{i} ( t = {t}_{o} ) ) / ( {t}_{1} - {t}_{o} )$$

The equation for Tₒ illustrates the time dependence. It may be used in some embodiments to get a more accurate measurement of the terms if needed. In some embodiments, the higher-order terms may be ignored.

With the HVAC system off,

$$k = ( {T}_{i} ( t = {t}_{1} ) - {T}_{i} ( t = {t}_{o} ) ) / [ ( {t}_{1} - {t}_{o} ) * ( {T}_{o} ( t = {t}_{o} ) - {T}_{i} ( t = {t}_{0} ) ) ]$$

where k is a function of time. The value k may be calculated for every x minutes.

For the following HVAC cycle, it may be assumed that k is constant for the HVAC cycle. Example embodiments take k as the peak of the distribution from the last cycle (If the cycles are very short, the average can be taken instead since a peak in a small sample size has less significance).

With the HVAC system on,

$$q = ( {T}_{i} ( t = {t}_{1} ) - {T}_{i} ( t = k ) ) / ( {t}_{1} - {t}_{o} ) - {k}_{peak from last cycle} ( {T}_{o} ( t = {t}_{o} ) - {T}_{i} ( t = {t}_{o} ) )$$

The q is the rate of heat added/removed with the HVAC system. This can be calculated every x minutes to produce a distribution.

The distribution of k and q may be provided to a user, for example as a plot. The value q may be referred to as “Rate of heating/cooling” and k as “Rate of energy lost to environment.”

### Example System Hardware

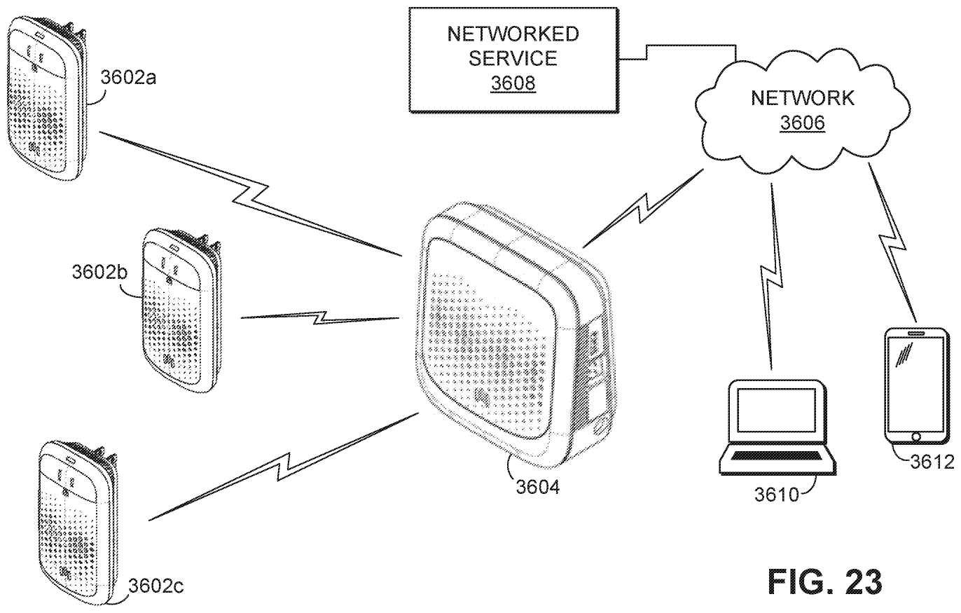

FIG. 23 schematically illustrates network topology used in some embodiments. One or more sensor nodes 3602a-c may be disposed in a residence, e.g. in different rooms. Each node may be plugged in to an electrical outlet. The sensor nodes are in wireless communication with a hub node 3604, e.g. using a WiFi connection or other local area network. The hub node 3604 may further have a connection to a wide-area network 3606 such as the internet through which a networked service 3608 running on one or more servers, such as a cloud service, may be accessed. Users may have personal devices such as a computer 3610 or mobile computing device 3612 that can also access the networked service 3608 over the network 3606. In some embodiments, the user interfaces described herein are displayed when the user accesses the networked service on their personal device. In some embodiments, the user's personal devices may be capable of communicating directly with the hub node 3604 and/or with the sensor nodes 3602a-c to view the user interfaces or to exchange other information. In some embodiments, the sensor nodes 3602a-c may be capable of communicating over the network 3606 without the intermediation of the hub node (e.g. through a router).

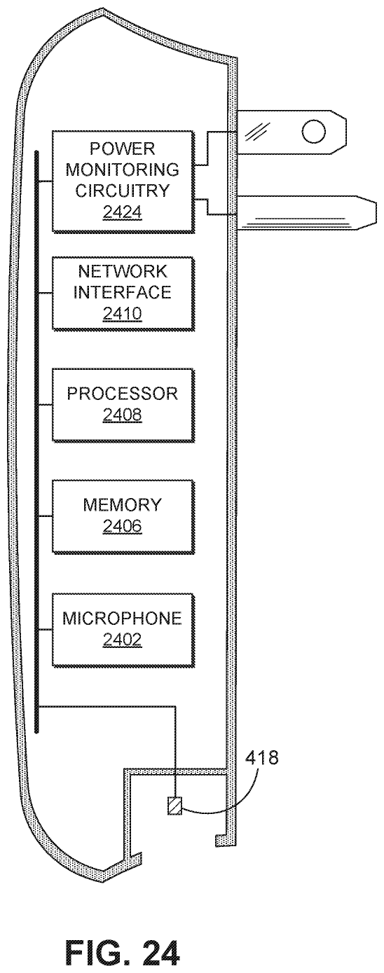

In example embodiments, as shown in FIG. 24, the sensor node includes a temperature sensor 418 in communication (e.g. over a bus or other internal connection) with a processor 2408. The temperature sensor is used in collecting the temperature measurements described herein. The sensor node may also include sensors that operate to assist in determining whether the HVAC system is in an “on” or an “off” state. For example, the sensor node may include a microphone 2402 that collects audio data that may be used in determining whether the HVAC system is in operation. In some embodiments, audio data is provided to the hub node to interpret the audio data of one or more sensor nodes to determine whether the HVAC system is in operation. The sensor node may further include power monitoring circuity 2424. Such circuitry may detect changes in power supply voltage that may be characteristic of the HVAC system being active or inactive, or changing states between active and inactive. The sensor node further includes a memory 2406, which may include a non-transitory memory. The memory may store collected data (e.g. temperature and audio data). The memory may further store instructions that are executable by the processor for causing the processor to perform any of the methods described herein. A network interface 2410 may be provided to allow for communication with hub devices, other sensor nodes, or other equipment.

The hub node likewise includes a memory, which may include a non-transitory memory, a processor, and one or more network interfaces for connection (e.g. a wireless connection) with the sensor nodes and with the internet (possibly through a router). The memory may store collected data (e.g. temperature and audio data) received from one or more sensor nodes. The memory may further store instructions that are executable by the processor for causing the processor to perform any of the methods described herein.

Any feature described herein as a module may be implemented with structures including, but not limited to, one or more processors and at least one storage medium (e.g. a non-transitory storage medium) storing instructions that are operative, when executed on the one or more processors, to perform any functions associated with the module. Such a module may further include any appropriate environmental sensors (e.g. a thermometer, hygrometer, microphone) or input or output devices (e.g. screens, keyboards, network interfaces) used to implement the functions associated with the module. In some embodiments, computing operations may be implemented by circuitry other than a processor, such as by a field-programmable gate array (FPGA) or other logic circuitry. The componentry used to implement a module may in some embodiments be distributed among different physical devices that communicate with one another to perform the associated functions.

### Further Embodiments

In some embodiments, a method includes monitoring an HVAC system to detect (e.g., to detect automatically) a plurality of sample intervals during which the HVAC system is active; monitoring an ambient temperature to determine a temperature change over each of the respective sample intervals; and determining a sample value for each of the sample intervals, each sample value representing a ratio between a duration of the interval and the temperature change over the course of the respective interval.

Some such embodiments further include detecting (e.g., automatically detecting) a change in HVAC performance based on a comparison between sample values collected in a first time period and sample values collected in a second time period.

In some embodiments, a plurality of ambient temperature (and/or other environmental parameter) readings are obtained at a plurality of sensor devices, and a determination of HVAC effectiveness is made based on the plurality of ambient temperature readings.

Some embodiments further include generating a histogram of the sample values and displaying the histogram to a user.

Some embodiments further include determining and displaying to a user at least one of the following: a mode, a median, an average, an upper quintile of the sample values, a lower quintile of the sample values, or a change in at least one of the foregoing over time.

Some embodiments further include, for each of a plurality of bins, each bin being associated with a range of sample values, determining a number of the sample values that fall within the associated range to generate histogram data; and fitting a curve to the histogram data. Some such embodiments further include detecting a change in HVAC performance by detecting a change between (i) at least one first parameter of a first curve fitted to a first histogram of sample values collected in a first time period and (ii) at least one second parameter of a second curve fitted to a second histogram of sample values collected in a second time period.

In some embodiments, each sample interval is a single “on” cycle extending from a time the HVAC system becomes active to a time it becomes inactive.

In some embodiments, each sample interval is an interval of a predetermined duration.

In some embodiments, the plurality of sample intervals during which the HVAC system is active is a plurality of sample intervals during which the HVAC system is performing a heating operation.

In some embodiments, the plurality of sample intervals during which the HVAC system is active is a plurality of sample intervals during which the HVAC system is performing a cooling operation.

A method according to some embodiments includes monitoring an HVAC system to detect a plurality of sample intervals during which the HVAC system is inactive; monitoring an ambient temperature to determine a temperature change over each of the respective sample intervals; and determining a sample value for each of the sample intervals, each sample value representing a ratio between a duration of the interval and the temperature change over the course of the respective period.

Some such embodiments further include detecting a change in heat retention or exclusion performance based on a comparison between sample values collected in a first time period and sample values collected in a second time period.

Some embodiments further include generating a histogram of the sample values and displaying the histogram to a user.

Some embodiments further include determining and displaying to a user at least one of the following: a mode, a median, an average, an upper quintile, or a lower quintile of the sample values.

Some embodiments further include: for each of a plurality of bins, each bin being associated with a range of sample values, determining a number of the sample values that fall within the associated range to generate histogram data; and fitting a curve to the histogram data.

Some embodiments further include detecting a change in heat retention or exclusion performance by detecting a change between (i) at least one first parameter of a first curve fitted to a first histogram of sample values collected in a first time period and (ii) at least one second parameter of a second curve fitted to a second histogram of sample values collected in a second time period.

In some embodiments, each sample interval is a single “off” cycle extending from a time the HVAC system becomes inactive to a time it becomes active.

In some embodiments, each sample interval is an interval of a predetermined duration.

An apparatus and/or system according to some embodiments includes at least one processor configured to perform one or more of the methods described herein.

A system according to some embodiments includes a module configured to monitor an HVAC system to detect a plurality of sample intervals during which the HVAC system is active; a module configured to monitor an ambient temperature to determine a temperature change over each of the respective sample intervals; and a module configured to determine a sample value for each of the sample intervals, each sample value representing a ratio between a duration of the interval and the temperature change over the course of the respective period.

Some such embodiments further include a module configured to detect a change in HVAC performance based on a comparison between sample values collected in a first time period and sample values collected in a second time period.

Some embodiments further include a module configured to generate a histogram of the sample values and a module configured to cause the displaying of the histogram to a user.

Some embodiments further include a module configured to determine and display to a user at least one of the following: a mode, a median, an average, an upper quintile, or a lower quintile of the sample values.

Some embodiments further include a module configured to generate histogram data, the module being operative, for each of a plurality of bins, each bin being associated with a range of sample values, to determine a number of the sample values that fall within the associated range; and a module configured to fit a curve to the histogram data.

Some embodiments further include a module configured to detect a change in HVAC performance by detecting a change between (i) at least one first parameter of a first curve fitted to a first histogram of sample values collected in a first time period and (ii) at least one second parameter of a second curve fitted to a second histogram of sample values collected in a second time period.

In some embodiments, each sample interval is a single “on” cycle extending from a time the HVAC system becomes active to a time it becomes inactive.

In some embodiments, each sample interval is an interval of a predetermined duration.

In some embodiments, the plurality of sample intervals during which the HVAC system is active is a plurality of sample intervals during which the HVAC system is performing a heating operation.

In some embodiments, the plurality of sample intervals during which the HVAC system is active is a plurality of sample intervals during which the HVAC system is performing a cooling operation.

A system according to some embodiments includes a module configured to monitor an HVAC system to detect a plurality of sample intervals during which the HVAC system is inactive; a module configured to monitor an ambient temperature to determine a temperature change over each of the respective sample intervals; and a module configured to determine a sample value for each of the sample intervals, each sample value representing a ratio between a duration of the interval and the temperature change over the course of the respective period.

Some such embodiments further include a module configured to detect a change in heat retention or exclusion performance based on a comparison between sample values collected in a first time period and sample values collected in a second time period.

Some embodiments further include a module configured to generate a histogram of the sample values and a module configured to cause display of the histogram to a user.

Some embodiments further include a module configured to determine and display to a user at least one of the following: a mode, a median, an average, an upper quintile, or a lower quintile of the sample values.

Some embodiments further include a module configured to generate histogram data, the module being operative, for each of a plurality of bins, each bin being associated with a range of sample values, to determine a number of the sample values that fall within the associated range to generate histogram data; and a module configured to fit a curve to the histogram data.

Some embodiments further include a module configured to detect a change in heat retention or exclusion performance by detecting a change between (i) at least one first parameter of a first curve fitted to a first histogram of sample values collected in a first time period and (ii) at least one second parameter of a second curve fitted to a second histogram of sample values collected in a second time period.

In some embodiments, each sample interval is a single “off” cycle extending from a time the HVAC system becomes inactive to a time it becomes active.

In some embodiments, each sample interval is an interval of a predetermined duration.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Other variations of the described embodiments are contemplated. The above-described embodiments are intended to be illustrative, rather than restrictive, of the present invention. The scope of the invention is thus not limited by the examples given above but rather is defined by the following claims.

1. A method comprising:
monitoring an HVAC system to detect a plurality of sample intervals during which the HVAC system is active;
monitoring an environmental parameter during each of the respective sample intervals; and
determining a sample value for each of the sample intervals, each sample value representing a rate of change of the environmental parameter in the respective interval.

2. The method of claim 1, further comprising detecting a change in HVAC performance based on a comparison between a first plurality of sample values collected in a first time period and a second plurality of sample values collected in a second time period.

3. The method of claim 1, wherein the sample value for a sample interval is a ratio between a duration of the respective interval and a total change in the environmental parameter over the course of the respective interval.

4. The method of claim 1, wherein the sample value for a sample interval is a slope or inverse slop value representing a rate of change of the environmental parameter during at least a portion of the sample interval.

5. The method of claim 1, wherein the environmental parameter is temperature.

6. The method of claim 1, further comprising:
for each of a plurality of bins, each bin being associated with a range of sample values, determining a number of the sample values that fall within the associated range to generate histogram data;
fitting a curve to the histogram data; and
detecting a change in HVAC performance based on a change over time in at least one parameter of the curve.

7. The method of claim 1, wherein monitoring the HVAC system comprises collecting audio data, and wherein the detection of a sample interval during which the HVAC system is active is based at least in part on the audio data.

8. The method of claim 1, wherein monitoring the HVAC system comprises collecting electrical transient data, and wherein the detection of a sample interval during which the HVAC system is active is based at least in part on the electrical transient data.

9. A system comprising:
at least one sensor node configured to monitor at least a first parameter and at least a second parameter, the second parameter being an environmental parameter;
at least one processor configured to perform at method comprising:
detecting, based at least in part on the first parameter, a plurality of sample intervals during which an HVAC system is active; and
determining a sample value for each of the sample intervals, each sample value representing a rate of change of the environmental parameter in the respective interval.

10. The system of claim 9, wherein the at least one processor is further configured to detect a change in HVAC performance based on a comparison between a first plurality of sample values collected in a first time period and a second plurality of sample values collected in a second time period.

11. The system of claim 9, wherein the sample value for a sample interval is a ratio between a duration of the respective interval and a total change in the environmental parameter over the course of the respective interval.

12. The system of claim 9, wherein the sample value for a sample interval is a slope or inverse slop value representing a rate of change of the environmental parameter during at least a portion of the sample interval.

13. The system of claim 9, wherein the environmental parameter is temperature.

14. The system of claim 9, wherein the at least one processor is further configured to perform:
for each of a plurality of bins, each bin being associated with a range of sample values, determining a number of the sample values that fall within the associated range to generate histogram data;
fitting a curve to the histogram data; and
detecting a change in HVAC performance based on a change over time in at least one parameter of the curve.

15. The system of claim 9, wherein the first parameter is audio data, and wherein the detection of a sample interval during which the HVAC system is active is based at least in part on the audio data.

16. The system of claim 9, wherein the first parameter is electrical transient data, and wherein the detection of a sample interval during which the HVAC system is active is based at least in part on the electrical transient data.

17. A system comprising:
at least one sensor node configured to monitor temperature and at least one additional parameter;
at least one processor configured to perform a method comprising:
detecting, based at least in part on the additional parameter, a plurality of sample intervals during which an HVAC system is inactive; and
determining a sample value for each of the sample intervals, each sample value representing a rate of change of the temperature in the respective interval; and
detecting a change in heat retention or exclusion performance based on a comparison between sample values collected in a first time period and sample values collected in a second time period.

18. The system of claim 17, wherein the additional parameter is at least one of audio data and voltage transient data.

19-20. (canceled)
